(19) United States
(12) Patent Application Publication
(10) Pub. No.: US 2017/0297399 A1
(43) Pub. Date: Oct. 19, 2017

(54) SIGNAL PROCESSING DEVICE

(71) Applicant: KYB Corporation, Tokyo (JP)

(72) Inventors: Tomoo KUBOTA, Tokyo (JP); Masatoshi OKUMURA, Tokyo (JP)

(73) Assignee: KYB Corporation, Tokyo (JP)

(21) Appl. No.: 15/514,317

(22) PCT Filed: Dec. 4, 2015
(86) PCT No.: PCT/JP2015/084106

§ 371 Date: Mar. 24, 2017

Related U.S. Application Data
(63) Continuation of application No. PCT/JP2015/084106, filed on Dec. 4, 2015.

(30) Foreign Application Priority Data
Dec. 4, 2014 (JP) 2014-245979

(51) Int. Cl. B60G 17/018

(52) U.S. Cl. CPC B60G 17/018; B60G 2500/10

(57) ABSTRACT

An object is to provide a signal processing device capable of reducing a sudden change in the rate of change of an output signal at the time of switching between two signals. In the signal processing device, when a signal of a larger value is selected, a smoothing signal is generated based on the deviation between two signals such that the smoothing signal has a value larger than the values of the two signals between two points at which the smoothing signal intersects the two signals, or when a signal of a smaller value is selected, the smoothing signal is generated based on the deviation between two signals such that the smoothing signal has a value smaller than the values of the two signals between two points at which the smoothing signal intersects the two signals.

### TECHNICAL FIELD

The present invention relates to a signal processing device.

### BACKGROUND ART

Control used in damper control devices for controlling the damping force of dampers interposed between spring upper members and spring lower members of vehicles includes well-known skyhook control the object of which is to reduce vibrations of the spring upper members, focusing on vibrations of the spring upper members. In addition to the skyhook control, roll/pitch control for reducing rolling and pitching of the spring upper members is sometimes combined to control the damping force of dampers, as disclosed in JP 2006-44523 A, for example.

This damper control device provides control commands to a damping force adjustment mechanism that changes damping force produced by a damper according to a supply current, to control the damping force. Specifically, the damper control device determines a skyhook control current as a control command to be provided to the damping force adjustment mechanism in accordance with the skyhook control, and determines a roll/pitch control current as a control command to be provided to the damping force adjustment mechanism in accordance with the roll/pitch control, selects one of the two control commands having a larger value, and supplies this actually as a final control command to the damping force adjustment mechanism of the damper, to control the damping force of the damper.

For switching between the control commands, for example, in a situation where the skyhook control current is selected, switching to the roll/pitch control current is performed at the instant when the roll/pitch control current exceeds the skyhook control current, so that the control current does not become discontinuous.

### SUMMARY OF THE INVENTION

Switching between the skyhook control current and the roll/pitch control current at the instant when one exceeds the other as in the invention disclosed in JP 2006-44523 A certainly prevents the value of an output control command itself from being discontinuous. However, simply switching between the skyhook control current and the roll/pitch control current can cause a sudden change in the rate of change of a control command output before the switching and after the switching.

Dampers with low damping force generation responsivity do not suddenly change in damping force due to delays in their responses even when the rates of change of control commands change suddenly. However, recent dampers with high damping force generation responsivity using magnetorheological fluids, electrological fluids, and the like can suddenly change in damping force due to sudden changes in the rates of change of control commands, deteriorating rides in vehicles.

As a measure to avoid this, it is conceivable to reduce a sudden change in the rate of change of a control command at the time of switching between control commands by fading in a control command selected from this time on while fading out a control command that has been selected up to that time. For example, as illustrated in FIG. 27, a control command α to be faded out is multiplied by a gain Gα that decreases linearly from one to zero, and a control command β to be faded in is multiplied by a gain Gβ that increases linearly from zero to one, and these are synthesized to output a control command. As illustrated in FIG. 28, the synthesized control command gradually switches from the control command α to the control command β over time.

However, this way of switching by fading in and fading out control commands cannot avoid a sudden change in the damping force of a damper with high damping force generation responsivity because the rate of change of a control command synthesized at the start and at the end of fade-in and fade-out changes suddenly. In the above description, a problem has been described, using, as an example, an effect of a sudden change in a control command on damping force in damper control. Other than damper control, a sudden change in the rate of change of a signal at the time of switching between two signals adversely affects the control of apparatuses with high responsivity to control commands, and the like.

Thus, the present invention has been made to solve the above problems, and its object is to provide a signal processing device capable of reducing a sudden change in the rate of change of an output signal.

In order to achieve the above object, in a signal processing device according to a means to solve the problems of the present invention, when a signal of a larger value is selected, a smoothing signal is generated based on a deviation between two signals such that the smoothing signal has a value larger than the values of the two signals between two points at which the smoothing signal intersects the two signals, or when a signal of a smaller value is selected, a smoothing signal is generated based on a deviation between two signals such that the smoothing signal has a value smaller than the values of the two signals between two points at which the smoothing signal intersects the two signals.

### BRIEF DESCRIPTION OF DRAWINGS

FIG. 1 is a configuration diagram of a signal processing device in a first embodiment.

FIG. 2 is a block diagram of control in a signal extractor.

FIG. 3 is an example of a smoothing signal that smoothes switching between two signals when high select processing is performed.

FIG. 4 is a flowchart illustrating an example of a processing procedure of generating a smoothing signal in the first embodiment.

FIG. 5 is an example of a smoothing signal that smoothes switching between two signals when low select processing is performed.

FIG. 6 is a flowchart illustrating an example of a processing procedure of the signal processing device in the first embodiment.

FIG. 7 is a diagram illustrating a first configuration example of a smoothing processor.

FIG. 8 is a graph illustrating two signals to be synthesized.

FIG. 9 is a graph illustrating the two signals and a smoothing signal obtained by synthesizing them.

FIG. 10 is a graph illustrating a procedure of synthesizing simple two signals.

FIG. 11 is a graph illustrating a first gain and a second gain by which the simple two signals are multiplied.

FIG. 12 is a graph illustrating a first additional signal, a second additional signal, and a smoothing signal.

FIG. 13 is a graph illustrating an interval in which the absolute value of the deviation between typical two signals is lower than or equal to a threshold.

FIG. 14 is a graph illustrating functions obtained by subtracting one signal from the other signal.

FIG. 15 is a graph illustrating the functions in FIG. 14 normalized.

FIG. 16 is a graph illustrating functions obtained by transforming the functions in FIG. 15, which change in a range between zero and one on the y axis.

FIG. 17 is a graph illustrating a first gain and a second gain obtained from the functions in FIG. 16.

FIG. 18 is a graph illustrating two signals that change in a range between zero and a predetermined value on the y axis.

FIG. 19 is a graph illustrating a normalized smoothing signal.

FIG. 20 is a graph illustrating a smoothing signal.

FIG. 21 is a diagram illustrating a second configuration example of the smoothing processor.

FIG. 22 is a map determining the relationship between a deviation and an additional value.

FIG. 23 is a map determining the relationship between an additional value gain and a selected signal.

FIG. 24 is a configuration diagram of a signal processing device in a second embodiment.

FIG. 25 is a configuration diagram of a signal processing device in a third embodiment.

FIG. 26 is a diagram illustrating a third configuration example of the smoothing processor.

FIG. 27 is a graph illustrating two signals and gains by which the signals are multiplied in the conventional art.

FIG. 28 is a graph illustrating a control command obtained by synthesizing the two signals using the gains in the conventional art.

### DESCRIPTION OF EMBODIMENTS

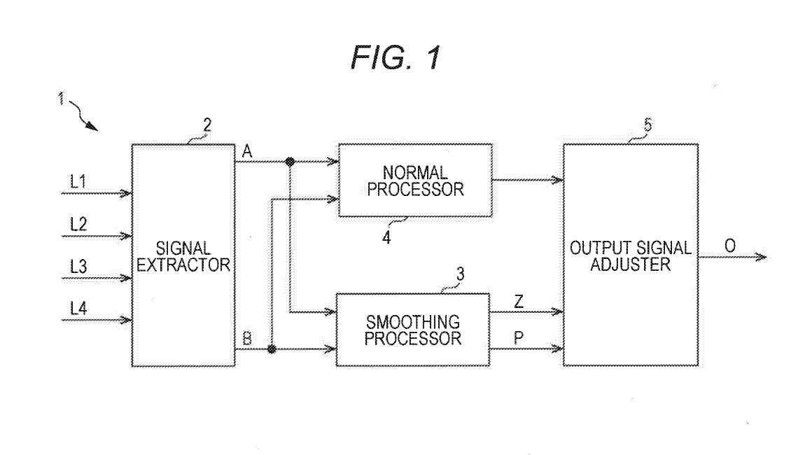

Hereinafter, the present invention will be described, based on embodiments illustrated in the drawings. As illustrated in FIG. 1, a signal processing device 1 in a first embodiment includes a signal extractor 2 that extracts two signals A and B from a plurality of signals L1, L2, L3, and L4, and a smoothing processor 3 that generates a smoothing signal P based on the deviation ε between the two signals A and B. The signal processing device 1 generates the smoothing signal P that reduces a sudden change in the rate of change of a signal at the time of switching when a selected signal of the two signals A and B is switched.

The signal processing device 1 in the first embodiment performs the so-called high select processing in this example. The signal extractor 2 extracts a signal having the largest value and a signal having the second largest value as the two signals A and B from the plurality of signals L1, L2, L3, and L4.

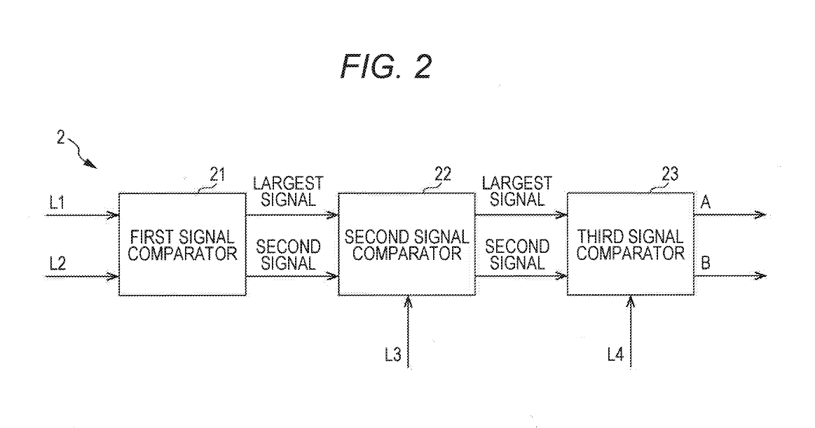

As illustrated in FIG. 2, the signal extractor 2 has a first signal comparator 21, a second signal comparator 22, and a third signal comparator 23. Since the signal processing device 1 performs the high select processing in this embodiment, a signal having the largest value and a signal having the second largest value are extracted as the signals A and B from the plurality of signals L1, L2, L3, and L4. Since the signal processing device 1 generates the smoothing signal P from the two signals A and B and the deviation ε between them, the signal extractor 2 extracts the two signals A and B.

The first signal comparator 21 first compares two signals of the plurality of signals L1, L2, L3, and L4, and takes a signal having a larger value as a temporary largest signal, and takes a signal having a smaller value as a temporary second signal as a signal having the second largest value. The first signal comparator 21 receives the input of two signals, e.g. the signal L1 and the signal L2, of the signals L1, L2, L3, and L4, compares them, and takes a signal having a larger value as a temporary largest signal, and takes a signal having a smaller value as a temporary second signal. Specifically, when the values of the signal L1 and the signal L2 are in a relationship of L1>L2, the first signal selector 21 outputs the largest signal as the signal L1, and the second signal as the signal L2. When the signal L1 and the signal L2 have the same value, one signal may be used as the largest signal and the other signal as the second signal for the sake of expediency.

The second signal comparator 22 adds one of the remaining signals to the two signals compared in the first signal comparator 21, compares three signals, the temporary largest signal, the temporary second signal, and the signal newly added to them, and takes a signal of the largest value as a temporary largest signal, and a signal of the second largest value as a temporary second signal. For example, the second signal comparator 22 adds the signal L3, one of the remaining signals L3 and L4 that have not been compared, to the signals L1 and L2 compared in the first signal comparator 21 for comparison. When the first signal comparator 21 has taken the temporary largest signal as the signal L1, and the temporary second signal as the signal L2, the second signal comparator 22 receives the input of the signal L3, compares it with the signals L1 and L2, and takes a signal having the largest value as a temporary largest signal and a signal having the second largest value as a temporary second signal. Specifically, when the values of the signal L1, the signal L2, and the signal L3 are in a relationship of L1>L3>L2, the second signal comparator 22 outputs the largest signal as the signal L1, and the second signal as the signal L3. When the signal L1 and the signal L3 have the same value, one signal may be taken as the largest signal and the other signal as the second signal for the sake of expediency. When the signal L3 and the signal L2 have the same value, one signal may be taken as the second signal for the sake of expediency.

The third signal comparator 23 adds a signal that has not been compared, to the signals taken as the temporary largest signal and the temporary second signal by the second signal comparator 22, compares three signals, the temporary largest signal, the temporary second signal, and the newly added signal, and takes a largest signal as a largest signal and a second largest signal as a second signal. Specifically, for example, the third signal comparator 23 receives the input of the remaining signal L4 that has not been compared in addition to the signal L1 taken as the largest signal and the signal L3 taken as the second signal based on the results of comparison by the second signal comparator 22 as described above, compares the values of the signals L1, L3, and L4, and extracts a signal having the largest value and a signal having the second largest value. Then, the third signal comparator 23 outputs the extracted two signals A and B. Specifically, when the signal L1, the signal L3, and the signal L4 are in a relationship of L4>L1>L3, the third signal comparator 23 extracts two signals of the signal L4 and the signal L1 as the signals A and B, and outputs the signals A and B to the smoothing processor 3. When the signal L1 and the signal L3 have the same value, one signal may be taken as a signal to be extracted and the other signal not to be extracted for the sake of expediency. By completing the procedure in the first signal comparator 21, the second signal comparator 22, and the third signal comparator 23, the signal extractor 2 can extract and output the two signals A and B. The signal extractor 2 is aimed at extracting the signal A and the signal B, and does not associate the signal A and the signal B each with the corresponding one of the largest value signal and the second largest signal for output. When necessary, the signal A and the signal B may each be associated with the corresponding one of the largest value and the second value for output.

Thus, in the extraction of the signal A and the signal B from a plurality of signals, first, a temporary largest signal and a temporary second signal are determined from two signals, and then the second signal comparator 22 and the third signal comparator 23 compares a signal that has not been compared with the compared two signals to determine a largest signal and a second signal. Since the number of signals is four in this example, by comparing the signals in the three signal comparators 21, 22, and 23, a largest signal and a second signal can be extracted. When the number of signals to be processed is made larger than that in this example, by repeating, according to the number of signals, the procedure performed in the second and third signal comparators 22 and 23, in which a largest signal and a second signal are determined from three signals at all times in and after the second signal comparator 22, comparing all the signals, the signal A and the signal B can be extracted. Thus, an increase in the number of signals does not change the procedure itself in and after the second signal comparator 22. Therefore, when the signal extractor 2 is made by a program that causes a computer to execute the above procedure, an increase in the number of signals only requires increasing the procedure in the signal comparators by the number of times corresponding to the number of signals. This is advantageous in making programming very simple, eliminating the need for special programming according to the number of signals. The signal extractor 2 only needs to be able to extract the signals A and B from two or more signals. Two signals first input to the first signal comparator 21 may be determined as desired, and may be the signals L3 and L4 instead of the signals L1 and L2, and are not limited to particular ones.

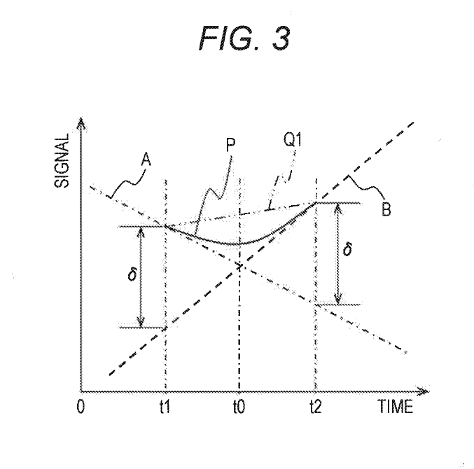

In this case, the high select processing in which a signal of a larger value is selected is used. Therefore, the smoothing processor 3 generates a smoothing signal P having a value larger than the values of the two signals A and B between two points at which the smoothing signal P intersects the two signals A and B, based on the deviation ε between the two signals A and B. Since the so-called high select processing is performed in this example, as illustrated in FIG. 3, when the signal A decreases in value with the lapse of time, and the signal B increases in value with the lapse of time, and the signals A and B intersect at a time, the signal A is selected before a time t0 at which the signals A and B intersect, and the signal B is selected at and after the time t0. The smoothing signal P is generated such that the difference from the values of the signals A and B is small when the absolute value of the deviation ε is large, and the difference from the signals A and B is large when the absolute value of the deviation ε is small. The smoothing signal P connects the two signals A and B at the time of switching between the signals A and B to reduce a sudden change in the rate of change of the signal at the time of signal switching. Specifically, the smoothing processor 3 adds an additional value av determined based on the deviation ε to a signal of a larger value of the two signals A and B to generate the smoothing signal P, or generates the smoothing signal P based on the values of the two signals A and B the deviation ε. As illustrated in FIG. 3, the smoothing signal P thus generated according to the deviation ε always has a larger value than these two signals A and B between two points at which the smoothing signal P intersects the two signals A and B, connecting the signals A and B. Since the smoothing signal P is thus a signal always having a larger value than the two signals A and B between the two points at which the smoothing signal P intersects the two signals A and B, the inclination of the smoothing signal P becomes larger than the inclination of the signal A while the signal A is selected, and the inclination of the smoothing signal P becomes smaller than the inclination of the signal B while the signal B is selected, as illustrated in FIG. 3. Therefore, compared to switching a selected signal directly from the signal A to the signal B at the time of switching between the two signals A and B, using the generated smoothing signal P between the two points from the intersection of the smoothing signal P and the signal A to the intersection of the smoothing signal P and the signal B can reduce a sudden change in the rate of change of the signal at the time of switching between the signals A and B. By making the smoothing signal P a signal drawing a curve touching the signals A and B, a sudden change in the rate of change of the signal can be further reduced.

In addition to the condition that the smoothing signal P always have a larger value than the two signals A and B between the two points at which the smoothing signal P intersects the two signals A and B, as illustrated in FIG. 3, the smoothing processor 3 may generate the smoothing signal P such that, in a plane of signal magnitude and time, the smoothing signal P has a smaller value than a straight line Q1 connecting the coordinates of the value of the signal A selected in the high select processing at a time t1 at which the absolute value of the deviation ε between the signals A and B becomes lower than or equal to a threshold δ, and the coordinates of the value of the signal B selected in the high select processing at a time t2 at which the absolute value of the deviation ε between the signals A and B exceeds the threshold δ after the time t0. Then, the smoothing signal P is generated so as to fall within a range enclosed by the straight line Q1, the signal A in a range between the time t1 and the time t0, and the signal B in a range between the time t0 and the time t2 in FIG. 3. When the smoothing processor 3 generates the smoothing signal P in this manner, a sudden change in the rate of change of a signal can be more reliably reduced. By outputting the smoothing signal P in place of the signals A and B when the absolute value of the deviation ε is lower than or equal to the threshold δ, a sudden change in the rate of change of the signal can be reduced at the time of switching from the signal A to the signal B, or switching from the signal B to the signal A. Thus, in the present embodiment, the threshold δ is a value setting a specified range in which the smoothing signal P is output as valid in place of the signals A and B. That is, when the deviation ε is within the specified range, the smoothing signal P is output, so that the smoothing signal P can be used when the values of the two signals A and B become closer and signal switching is expected, and the smoothing signal P can be prevented from being used when the values of the two signals A and B are completely apart and the smoothing processing is unnecessary.

In addition to the condition that the smoothing signal P always have a larger value than the two signals A and B between the two points at which the smoothing signal P intersects the two signals A and B, the smoothing processor 3 may generate the smoothing signal P such that, in a plane of signal magnitude and time, the smoothing signal P is smaller than the value obtained by adding, to the value of the signal A selected in the high select processing, one half the value obtained by subtracting the absolute value of the deviation ε from the threshold δ setting the specified range. In this case, the smoothing signal P is generated so as to touch the signals A and B at the coordinates at which the absolute value of the deviation ε between the two signals becomes equal to the threshold δ, and to fall within the range of the value obtained by subtracting the deviation ε from the threshold δ with respect to a selected signal. When the smoothing signal P is generated in the smoothing processor 3 in this manner, a sudden change in the rate of change of a signal can be more reliably reduced.

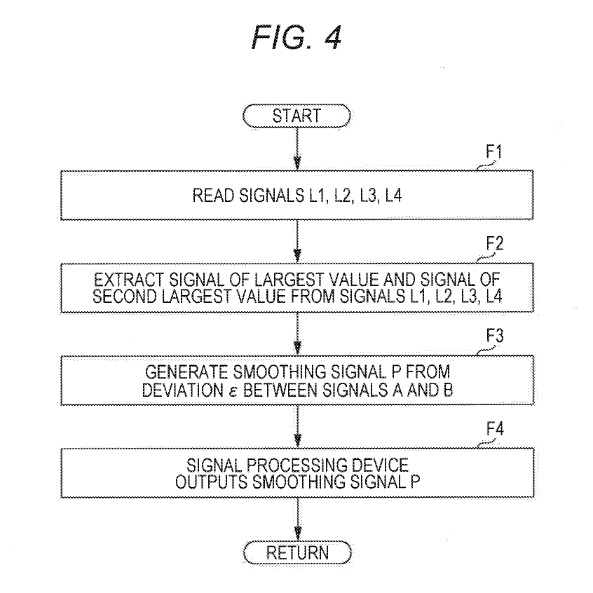

To perform the processing up to the above, as illustrated in FIG. 4, first, the signal processing device 1 reads the plurality of signals L1, L2, L3, and L4 (step F1). Next, the signal processing device 1 extracts a signal of the largest value and a signal of the second largest value from the signals L1, L2, L3, and L4 (step F2). Further, the signal processing device 1 uses the two signals extracted in step F1 as the signals A and B, and generates the smoothing signal P from the signals A and B and the deviation ε between the signals A and B (step F3). Next, the signal processing device 1 outputs the smoothing signal P (step F4). By repeating a series of processing above, the signal processing device 1 repeatedly generates and outputs the smoothing signal P.

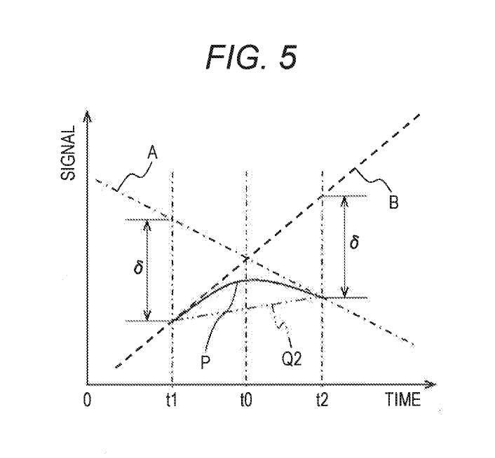

In the above description, to perform the high select processing, signals having the largest value and the second largest value are extracted as the signals A and B. To perform the so-called low select processing, a signal of the smallest value and a signal having the second smallest value can be extracted from the signals L1, L2, L3, and L4 as the signals A and B for output. When the low select processing is used, the smoothing processor 3 may generate a smoothing signal P having a value smaller than the values of the two signals A and B between two points at which the smoothing signal P intersects the two signals A and B, based on the deviation ε between the two signals A and B. As illustrated in FIG. 5, when the signal A decreases in value with the lapse of time, and the signal B increases in value with the lapse of time, and the two signals A and B intersect at a time, the use of the low select processing causes the signal B to be selected before a time t0 at which the two signals A and B intersect, and causes the signal A to be selected at and after the time t0. The smoothing signal P connects the two signals A and B at the time of switching between the two signals A and B to reduce a sudden change in the rate of change of the signal at the time of signal switching. Specifically, the smoothing processor 3 adds an additional value av determined based on the deviation ε to a signal of a smaller value of the two signals A and B to generate the smoothing signal P, or generates the smoothing signal P based on the values of the two signals A and B the deviation ε. As illustrated in FIG. 5, the smoothing signal P thus generated always has a smaller value than these two signals A and B between the two points at which the smoothing signal P intersects the two signals A and B, connecting the signals A and B. Since the smoothing signal P is thus a signal always having a larger value than the two signals A and B between the two points at which the smoothing signal P intersects the two signals A and B, the inclination of the smoothing signal P becomes smaller than the inclination of the signal A while the signal A is selected, and the inclination of the smoothing signal P becomes larger than the inclination of the signal B while the signal B is selected. Therefore, compared to switching a selected signal directly from the signal A to the signal B at the time of switching between the two signals A and B, using the generated smoothing signal P between the two points from the intersection of the smoothing signal P and the signal A to the intersection of the smoothing signal F and the signal B can reduce a sudden change in the rate of change of the signal at the time of switching between the signals A and B. By making the smoothing signal P a signal drawing a curve touching the signals A and B, a sudden change in the rate of change of the signal can be further reduced.

When the low select processing is performed, in addition to the condition that the smoothing signal P always have a smaller value than the two signals A and B between the two points at which the smoothing signal P intersects the two signals A and B, as illustrated in FIG. 5, the smoothing processor 3 can generate the smoothing signal P such that, in a plane of signal magnitude and time, the smoothing signal P has a larger value than a straight line Q2 connecting the coordinates of the value of the signal A selected in the high select processing at a time t1 at which the absolute value of the deviation ε between the signals A and B becomes lower than or equal to a threshold δ, and the coordinates of the value of the signal B selected in the low select processing at a time t2 at which the absolute value of the deviation ε between the signals A and B exceeds the threshold δ after the time t0. Then, the smoothing signal P is generated so as to fall within a range enclosed by the straight line Q2, the signal A in a range between the time t1 and the time t0, and the signal B in a range between the time t0 and the time t2 in FIG. 5. When the smoothing processor 3 generates the smoothing signal P in this manner, a sudden change in the rate of change of a signal can be more reliably reduced.

In addition to the condition that the smoothing signal P always have a smaller value than the two signals A and B between the two points at which the smoothing signal P intersects the two signals A and B, the smoothing processor 3 can generate the smoothing signal P such that, in a plane of signal magnitude and time, the smoothing signal P is larger than the value obtained by adding, to the value of the signal A selected in the low select processing, one half the value obtained by subtracting the absolute value of the deviation ε from the threshold δ setting the specified range. In this case, the smoothing signal P is generated so as to touch the signals A and B at the coordinates at which the absolute value of the deviation ε between the two signals becomes equal to the threshold δ, and to fall within the range of the value obtained by subtracting the deviation ε from the threshold δ with respect to a selected signal. When the smoothing signal P is generated in the smoothing processor 3 in this manner, a sudden change in the rate of change of a signal can be more reliably reduced.

As illustrated in FIG. 1, in addition to the above configuration, the signal processing device 1 in the present embodiment includes a normal processor 4 that extracts and outputs, as a largest value signal Ma, a signal to be output by the high select processing of the two signals A and B, for performing the high select processing, and an output signal adjuster 5 that selects and outputs the smoothing signal P generated by the smoothing processor 3 as an output signal O when the deviation ε between the signal A and the signal B is within the specified range, and selects and outputs the largest value signal Ma output by the normal processor 4 as the output signal O when the deviation ε is out of the specified range.

The normal processor 4 compares the input two signals A and B, and uses a signal having a larger value as the largest value signal Ma. The normal processor 4 is provided for performing the high select processing, compares the values of the signal A and the signal B, uses a signal of a larger value as the largest value signal Ma, and outputs it to the output signal adjuster 5. When it is desired to perform the low select processing, the normal processor 4 uses the smallest value of the signals A and B as a smallest value signal Mi, and outputs it to the output signal adjuster 5.

The present embodiment includes the normal processor 4 that compares the two signals A and B, and uses and outputs a signal having a larger value as the largest value signal Ma, and thus eliminates the need for the signal extractor 2 to associate the signal A and the signal B each with the corresponding one of the largest value signal and the second largest signal for output. As described above, the normal processor 4 compares the input two signals A and B, and uses a signal having a larger value as the largest value signal Ma. When the signal extractor 2 is configured to determine which of the largest value signal and the second largest signal the signals A and B each correspond to, the normal processor 4 can be integrated into the signal extractor 2.

The output signal adjuster 5 uses one of the smoothing signal P generated by the smoothing processor 3 and the largest value signal Ma output by the normal processor 4 as the output signal O, and outputs the output signal O. Specifically, in this embodiment, the output signal adjuster 5 receives the input of a smoothing determination signal Z from the smoothing processor 3, and determines which of the smoothing signal P and the largest value signal Ma to use as the output signal O, according to the smoothing determination signal Z. For example, the smoothing processor 3 outputs the smoothing determination signal Z having a value that allows determination of whether the smoothing signal P can be used or not when the absolute value of the deviation ε between the signals A and B is lower than or equal to the threshold δ and is within the specified range, and outputs the smoothing determination signal Z having a value indicating that the largest value signal Ma must be used when the absolute value of the deviation ε between the signals A and B exceeds the threshold δ and is out of the specified range. When the output signal adjuster 5 makes only two decisions of whether to use the smoothing signal P or not, the presence and absence of the output of the smoothing determination signal Z, that is, a desired value and zero may be output. When the output signal adjuster 5 fades the smoothing signal P in the largest value signal Ma for addition, or fades out the smoothing signal P, the smoothing determination signal Z may be output as a gain by which the smoothing signal P is multiplied, and the output signal adjuster 5 may add the value obtained by multiplying the smoothing signal P by the gain to the largest value signal Ma to determine the output signal O. The smoothing determination signal Z may be generated by the normal processor 4 instead of the smoothing processor 3.

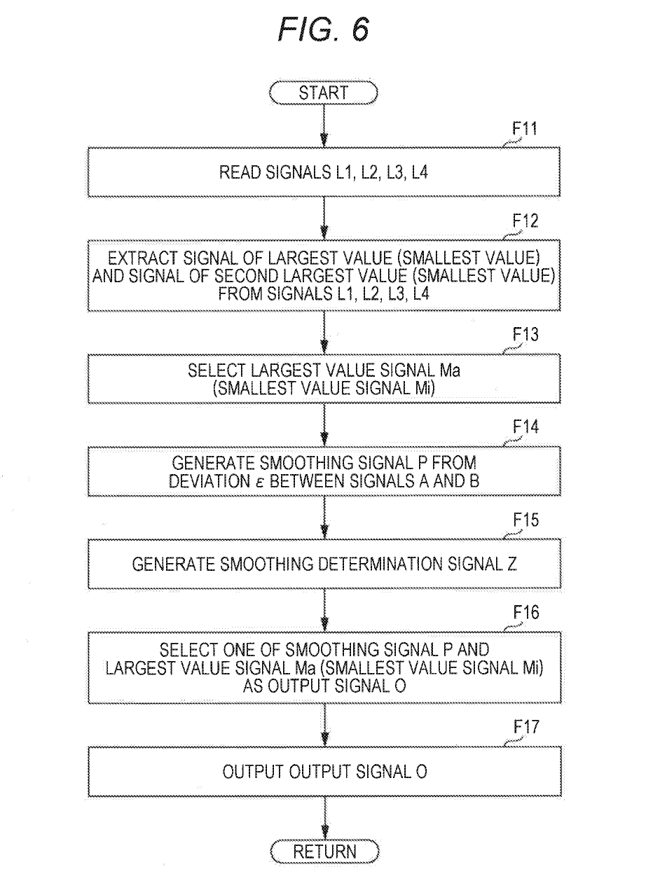

To perform the processing up to the above, as illustrated in FIG. 6, first, the signal processing device 1 reads the plurality of signals L1, L2, L3, and L4 (step F11). Next, the signal processing device 1 extracts a signal of the largest value and a signal of the second largest value from the signals L1, L2, L3, and L4 (step F12). Further, when the high select processing is performed, the signal processing device 1 uses the two signals extracted in step F11 as the signals A and B, and selects the largest value signal Ma of the signal A and the signal B. When the low select processing is performed, the signal processing device 1 performs processing of selecting the smallest value signal Mi of the signal A and the signal B (step F13). Next, the signal processing device 1 generates the smoothing signal P from the signals A and B and the deviation ε between the signals A and B (step F14). The signal processing device 1 compares the deviation ε between the signals A and B with the threshold δ to generate the smoothing determination signal Z (step F15). Further, based on the smoothing determination signal Z, the signal processing device 1 performs processing to select one of the smoothing signal P and the largest value signal Ma as the output signal O when the high select processing is performed, and performs processing to select one of the smoothing signal P and the smallest value signal Mi as the output signal O when the low select processing is performed (step F16). Finally, the signal processing device 1 outputs the output signal O (step F17). By repeating a series of processing above, the signal processing device 1 repeatedly generates and outputs the output signal O.

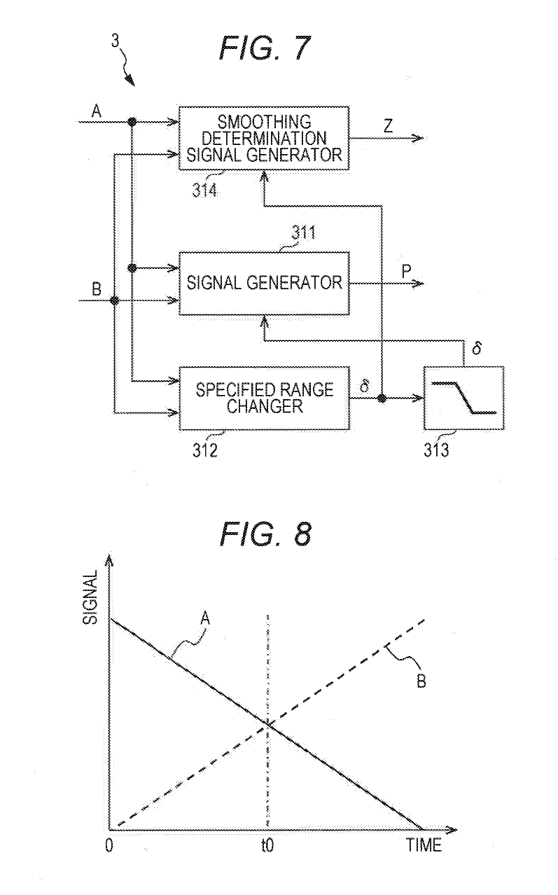

Next, the detailed configuration and processing in the smoothing processor 3 will be described. As illustrated in FIG. 7, a first configuration example of the smoothing processor 3 includes a signal generator 311 that performs an operation to determine the deviation ε between the signal A and the signal B extracted by the signal extractor 2, and generates the smoothing signal P based on the deviation ε, a specified range changer 312 that changes the value of the threshold δ that demarcates the specified range of smoothing in the generation of the smoothing signal P, a sudden change reduction processor 313 that reduces a sudden change in the specified range, and a smoothing determination signal generator 314 that compares the deviation ε between the signal A and the signal B and the threshold δ and generates the smoothing determination signal Z.

Specifically, the signal generator 311 determines, from the deviation ε between the signal A and the signal B, a first gain G₁ by which the value of the signal A is to be multiplied and a second gain G₂ by which the value of the signal B is to be multiplied, synthesizes a first additional signal H₁ obtained based on the value of the signal A and the first gain G₁ and a second additional signal H₂ obtained based on the value of the signal B and the second gain G₂ to determine a smoothing signal P, and outputs the smoothing signal P.

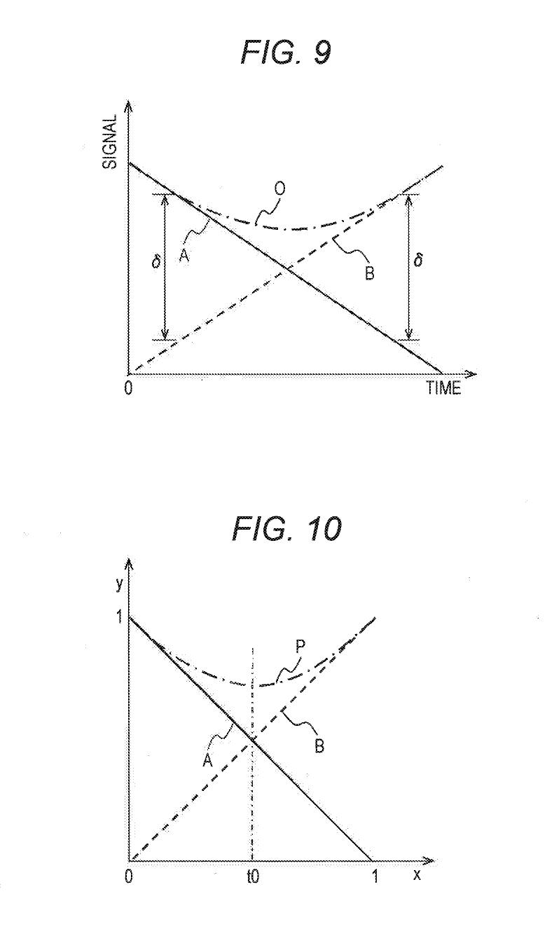

A procedure to determine the first gain G₁ and the second gain G₂ will be described. First, consider a situation where, as illustrated in FIG. 8, the signal A decreases with the lapse of time, the signal B increases with the lapse of time, and the signal A and the signal B intersect at a time t0. The signal processing device 1 in this embodiment performs the high select processing to select a signal of a larger value. When, before the time t0 at which the signal A and the signal B have the same value, the signal A having a larger value up to that time is selected, and at and after the time t0, the signal B having a larger value than the signal A is selected, an output signal suddenly changes in the rate of change at the time t0 of switching from the signal A to the signal B. Thus, as illustrated in FIG. 9, generating a signal connecting the signal A and the signal B smoothly near the intersection of them, and using this as the output signal O enable a smooth change from the signal A to the signal B.

First, consider synthesizing simple two signals, and determining the smoothing signal P connecting the signal A and the signal B smoothly. When an interval in which the signal A and the signal B are synthesized is considered in a range between zero and one in x, y coordinates with signal value taken on the y axis and time on the x axis, and the signal A is the linear function y=−x+1, and the signal B is y=x, the signal A and the signal B are as illustrated in FIG. 10 when illustrated in a graph. The smoothing signal P to be determined constitutes a curve as illustrated by a dot-dash line in FIG. 10. By using the smoothing signal P as a signal output in place of the signal A or the signal B in the interval ranging from zero to one in which the signal A and the signal B are synthesized, a sudden change in the rate of change of the output signal can be reduced.

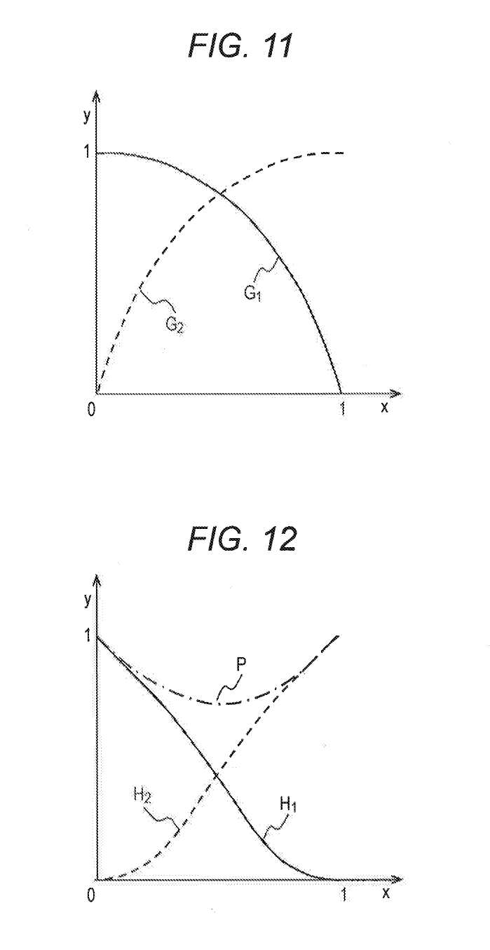

With respect to the signal A and the signal B when the first gain G₁ by which the signal A is multiplied is y=1−x², and the second gain G₂ by which the signal B is multiplied is y=1−(1−x)² as illustrated in FIG. 11, the first additional signal H₁ obtained by multiplying the signal A by the first gain G₁ is y=x³−x²−x+1, the second additional signal H₂ obtained by multiplying the signal B by the second gain G₂ is y=−x³+2x², and the smoothing signal P obtained by adding the first additional signal H₁ and the second additional signal H₂ is y=x²−x+1, as illustrated in FIG. 12.

As illustrated in FIG. 10, switching from the signal A to the smoothing signal P is at the point in time when x=0, and switching from the smoothing signal P to the signal B is at the point in time when x=1. The signal A is expressed by y=−x+1, and its differential is dy/dx=−1. The derivative value of the signal A at the point in time when x=0 is −1. The differentiation of y=x²−x+1 of the smoothing signal P results in dv/dx=2x−1, and the derivative value of the smoothing signal P when x=0 is −1. The signal B is expressed by y=x, and its differential is dy/dx=1. The derivative value of the signal B at the point in time when x=1 is 1. The substitution of x=1 into the differentiation dy/dx=2x−1 of the smoothing signal P results in that the derivative value of the smoothing signal P at the point in time when x=1 is 1. Thus, when an output signal is switched from the signal A to the smoothing signal P, and from the smoothing signal P to the signal B when the smoothing signal P connects the signal A and the signal B, the rate of change of the signal smoothly changes without a sudden change. Further, the rate of change of the smoothing signal P does not change suddenly because the smoothing signal P is a quadratic curve. Thus, by adding the signal A and the signal B multiplied by the first gain G₁ and the second gain G₂, respectively, the smoothing signal P can be determined.

Next, the procedure of determining the smoothing signal P is generalized. With the signal A as the function y=f₁(t) that changes over time t, and likewise with the signal B as the function y=f₂(t), the smoothing signal P is determined from the signal A and the signal B.

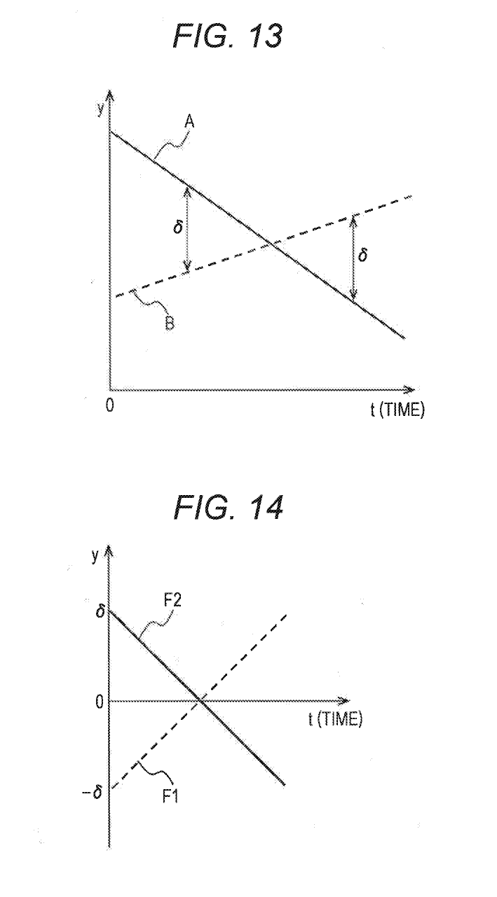

Consider an interval in which, as illustrated in FIG. 13, the value of the signal A decreases, the value of the signal B increases, the point in time when they intersect is included, and the absolute value of the deviation ε between them is lower than or equal to the threshold δ. The threshold δ is a value specifying the specified range in which the smoothing signal P is validated, by comparison with the deviation ε. As described above, with the range in which the absolute value of the deviation ε is lower than or equal to the threshold δ as the specified range, and with the smoothing signal P as valid within this specified range, by outputting the smoothing signal P in place of the signal A and the signal B in this range, a sudden change in the rate of change of the signal at the time of switching between the signal A and the signal B can be reduced.

First, the signal A is subtracted from the signal B to obtain a function F1, y=f₂−(t)−f₁(t), and the signal B is subtracted from the signal A to obtain a function F2, y=f₁(t)−f₂(t). A graph of the functions F1 and F2 in an interval in which the absolute value of the deviation between the signal A and the signal B is lower than or equal to the threshold δ is as illustrated in FIG. 14.

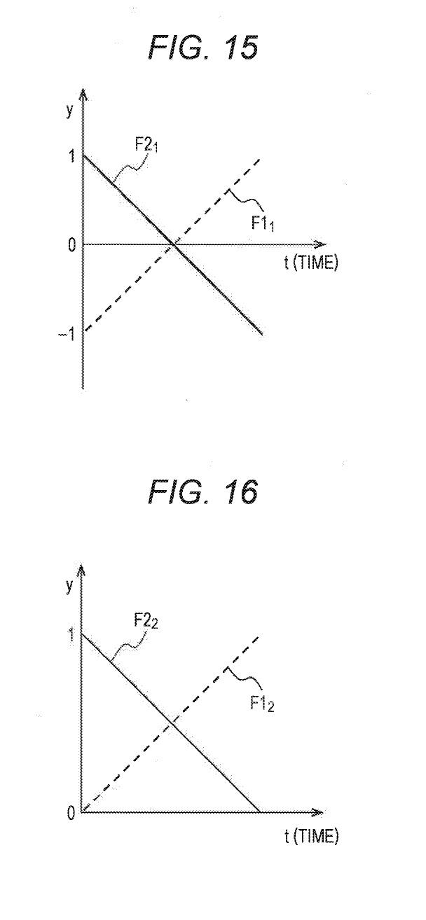

Next, the functions F1 and F2 obtained as described above are normalized so as to change in a range between zero and one on the y axis. Specifically, as illustrated in FIG. 15, the right sides of the functions F1 and F2 are divided by the threshold δ to transform function F1 to a function F1₁ expressed by y=(f₂(t)−f₁(t))/δ, and to transform the function F2 to a function F2₁ expressed by y=(f₁(t)−f₂(t))/δ, to obtain the functions F1₁ and F2₁ that change in a range between −1 and 1 on the y axis. Further, as illustrated in FIG. 16, the right sides of the functions F1₁ and F2₁ are divided by 2, and then 0.5 is added to them to transform the function F1₁ to a function F1₂ expressed y=(f₂(t)−f₁(t))/2δ+0.5, and to transform the function F2₁ to a function F2₂ expressed by y=(f₁(t)−f₂(t))/2δ+0.5, to obtain the functions F1₂ and F2₂ that change in a range between zero and one on the y axis.

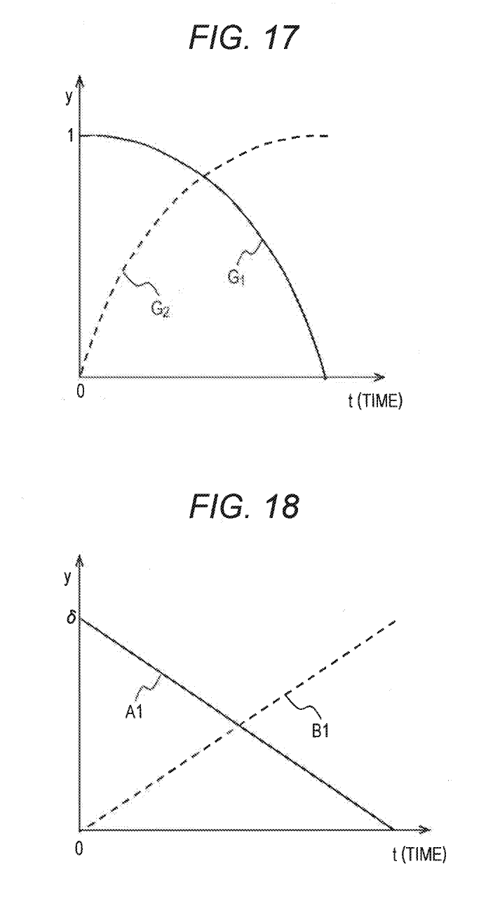

From the normalized functions F1₂ and F2₂, the first gain G₁ and the second gain G₂ are determined. As described above, with the first gain G₁ and the second gain G₂ as quadratic functions, the function F1₂ is multiplied by the first gain G₁ to obtain the first additional signal H₁, and further the function F2₂ is multiplied by the second gain G₂ to obtain the second additional signal H₂, so that the smoothing signal P obtained by adding the first additional signal H₁ and the second additional signal H₂ becomes a quadratic function. This prevents a sudden change in the rate of change of the signal both at connections when the signal A and the signal B are connected by the smoothing signal P and in the smoothing signal P. Thus, the right sides of the functions F1₂ and F2₂ are squared and then subtracted from one, individually, to make the first gain G₁, G₁=−{(f₂(t)−f₁(t))/2δ+0.5}²+1, and to make the second gain G₂, G₂=−{(f₁(t)−f₂(t))/2δ+0.5}²+1, so that, as illustrated in FIG. 17, the first gain G₁ and the second gain G₂ similar to the first gain G₁ and the second gain G₂ determined when simple signals are synthesized can be obtained. The first gain G₁ can be expressed by G₁=−(−ε/2δ+0.5)²+1, and the second gain G₂ can be expressed by G₂=−(ε/2δ+0.5)₂+1 where ε is the deviation obtained by subtracting the signal B from the signal A.

By thus obtaining the functions F1₂ and F2₂ from the signal A and the signal B, and determining the first gain G₁ end the second gain G₂, generalization can be made independently of the statuses of the signal A and the signal B. Thus, when the threshold δ is predetermined, the first gain G₁ and the second gain G₂ can be determined only by determining the deviation ε. Therefore, by mapping the first gain G₁ and the second gain G₂, and performing a map operation from the deviation ε, the first gain G₁ and the second gain G₂ can be determined. As described above, by obtaining the normalized functions F1₂ and F2₂ from the signal A and the signal B and determining the first gain G₁ and the second gain G₂, operation is advantageously facilitated. It is also possible to determine the first gain G₁ directly from the normalized signal A, and determine the second gain G₂ directly from the normalized signal B.

Next, with respect to the interval in which the absolute value of the deviation ε between the signal A and the signal B is lower than or equal to the threshold δ, the signal A and the signal B are normalized. Since the first gain or G₁ and the second gain G₂ are determined from the normalized functions F1₂ and F2₂, the normalization of the signal A and the signal B is required to multiply the signal A and the signal B by the first gain G₁ and the second gain G₂, respectively. That is, by returning a smoothing signal obtained by adding the first additional signal H₁ obtained by multiplying the normalized signal A by the first gain G₁ and the second additional signal H₂ obtained by multiplying the normalized signal B by the second gain G₂, to a state before normalization by a procedure reverse to the procedure by which the signal A and the signal B have been normalized, the intended smoothing signal P can be obtained.

First, the procedure to normalize the signal A and the signal B will be described. The signal A and the signal B are added and divided by two, and a value one half the threshold δ is subtracted from this, to obtain a correction value γ. Specifically, correction value γ=(f₁(t)+f₂(t))/2−δ/2.

The correction value γ is subtracted from the signal A and the signal B to obtain a signal A1 and a signal B1. The signal A1 is y=f₁(t)−{(f₁(t)+f₂(t))/2−δ/2}, and the signal B1 is y=f₂(t)−{(f₁(t)+f₂(t))/2−δ/2}. When the range between zero and the threshold δ is shown on the y axis, the signal A1 and the signal B1 change as illustrated in the graph in FIG. 18.

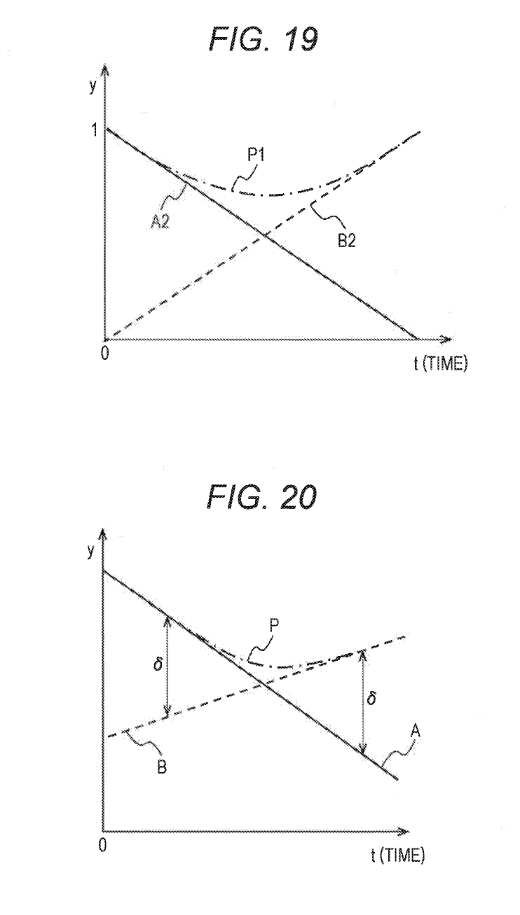

Further, when the right sides of the signals A1 and B1 are divided by the threshold δ, signals A2 and B2 to which the signal A and the signal B are normalized can be obtained. The signal A2 is y=[f₁(t)−{(f₁(t)+f₂(t))/2−δ/2}]/δ, and the signal B2 is y[f₂(t)−{(f₁(t)+f₂(t))/2−δ/2}]/δ. When the range between zero and one is shown on the y axis, the signal A2 and the signal B2 change as illustrated in the graph in FIG. 19.

The signal A2 obtained by normalizing the signal A in this manner is multiplied by the first gain G₁ determined from the function F1₂ to obtain the first additional signal H₁. The first additional signal H₁ is calculated by H₁=A2×G₁. Further, the signal B2 obtained by normalizing the signal B is multiplied by the second gain G₂ determined from the function F2₂ to obtain the second additional signal H₂. The second additional signal H₂ is calculated by H₂=B2×G₂.

Then, the first additional signal H₁ and the second additional signal H₂ are added to obtain a normalized smoothing signal P1. The normalized smoothing signal P1 is P1=H₃+H₂=A2×G₁+B2×G₂, and can be presented as illustrated in the graph in FIG. 19.

Since the smoothing signal P1 determined here is in a normalized state, the normalized smoothing signal P1 is transformed to a state before normalization, using the threshold δ and the above-described correction value γ.

Specifically, the transformed smoothing signal P=δ×(H₁+H₂)+γ=δ×(A2×G₁+B2×G₂)+γ. As illustrated in FIG. 20, the smoothing signal P can smoothly connect the signal A and the signal B in a range in which the absolute value of the deviation ε between them is lower than or equal to the threshold δ.

In the above description, in the interval in which the smoothing signal P is generated, the signal A becomes smaller than the signal B after the signal A intersects the signal B, and the signal A is multiplied by the first gain G₁ and the signal B is multiplied by the second gain G₂ to obtain the smoothing signal P. The difference between the respective formulas of the first gain G₁ and the second gain G₂ is only a difference in the sign preceding the deviation ε. Then, in calculation, when a signal having a larger value of the two signals A and B is multiplied by the first gain G₁ to obtain the first additional signal H₁, and a signal having a smaller value of the two signals A and B is multiplied by the second gain G₂ to obtain the second additional signal H₂, the calculation of the smoothing signal P results in the same value. More specifically, in the calculation of the smoothing signal P, the value of the smoothing signal P obtained by, up to the point in time when the signal A and the signal B intersect, determining the deviation ε by subtracting the signal B of a smaller value from the signal A of a larger value, and entering the value of the signal A in the value of f₁(t) and entering the value of the signal B in the value of f₂(t) and after the signal A intersects the signal B, determining the deviation ε by subtracting the signal A of a smaller value from the signal B of a larger value, and entering the value of the signal B in the value of f₁(t) and entering the value of the signal B in the value of f₂(t), agrees with the value of the smoothing signal P determined by determining the deviation ε by subtracting the signal B from the signal A, and entering the value of the signal A in the value of f₁(t) and entering the value of the signal B in the value of f₂(t).

Therefore, by multiplying a signal having a larger value of the two signals A and B by the first gain G₁ and multiplying a signal having a smaller value by the second gain G₂ at all times, the smoothing signal P can be obtained. Thus, with the signal A as f₁(t), and with the signal B as f₂(t), the deviation ε can be determined by ε=f₁(t)−f₂(t), the first gain G₁ can be determined by G₁=−(−ε/2δ+0.5)²+1, the second gain G₂ can be determined by G₂=−(ε/2δ+0.5)²+1, and the correction value γ can be determined by γ=(f₁(t)+f₂(t))/2−δ/2. To determine the smoothing signal P at a time T, when the value of the signal A at the time T is f₁(T)=a, and the value of the signal B at the time T is f₂(T)=b, the values a and b can be substituted into the above formulas for calculation. Further, for the normalization of the signal A and the signal B, a2 representing the value of the normalized signal A is calculated by a2=[a−{(a+b)/2−δ/2}]/δ, and b2 representing the value of the normalized signal B is calculated by b2=[b−{(a+b)/2−δ/2}]/δ, and the smoothing signal P can be determined by calculating P=δ×(a2×G₁+b2×G₂)+γ. As is understood from above, the signal generator 311 in the smoothing processor 3 obtains the first gain G₁ and the second gain G₂, based on the deviation ε between the signal A and the signal B, and generates the smoothing signal P using the first gain G₁ and the second gain G₂.

Instead of determining whether the smoothing signal P is valid or invalid or whether or not to generate the smoothing signal P by comparison between the absolute value of the deviation ε and the threshold δ, subtracting a signal of a smaller value from a signal of a larger value in the calculation of the deviation ε allows the same determination by comparison between the deviation ε and the threshold δ. In this determination, when one of the signals A and B is always subtracted from the other of the signals A and B, that is, the order of subtraction is determined, for example, to obtain the deviation ε, the threshold δ may be specified by two numbers of the same numerical value with different signs such as ±N (N is a numerical value) to validate the smoothing signal P in the same specified range as described above. Alternatively, a threshold to determine the condition when the deviation ε falls within the specified range, and a threshold to determine the condition when the deviation ε falls out of the specified range may be set at different numerical values.

Thus, when the signal processing device 1 performs the high select processing of selecting a signal having a larger value, by selecting a signal taking on a larger value of the signal A and the signal B, determining a first gain by calculating G₁=−(−ε/2δ+0.5)²+1, and determining a second gain by calculating G₂=−(ε/2δ+0.5)²+1, the first gain G₁ and the second gain G₂ can be determined only by determining the deviation ε, and the signal A and the signal B can be synthesized to obtain the smoothing signal P without complicated calculation.

Although the first gain G₁ and the second gain G₂ are derived using quadratic functions in the above description, they may be derived using trigonometric functions. In this case, the deviation ε is determined by ε=f₁(t)−f₂(t) where f₁(t) is the signal A and f₂(t) is the signal B, the first additional signal H1 is determined by H₁=1−a2×G₁ and the second additional signal H₂ is determined by H₂=1−b2×G₂, where the first gain G₁ is G₁=[cos{(δ+ε)π/2δ}+1]²/4, and the second gain G₂ is G₂=[ cos {(δ−ε)π/2δ}+1]²/4, and, as in the above description, a2 is the value of the normalized signal A, and b2 is the value of the normalized signal B, and for the smoothing signal P, P=δ×(H₁+H₂)+γ is calculated. Thus using trigonometric functions also allows the generation of the smoothing signal P connecting both a signal before switching and a signal after switching by a smooth curve at the time of switching from the signal A to the signal B or from the signal B to the signal A, to reduce a sudden change in the rate of change of the signal at the time of switching between the signals A and B. Although cosine functions are used for the first gain G₁ and the second gain G₂ in the above description, sine functions may be used for definition.

When the so-called low select processing to select a signal of the smallest value from the signals L1, L2, L3, and L4 is performed, the smoothing signal P may be generated using a signal of the smallest value and a signal of the second smallest value of the signals L1, L2, L3, and L4 as the signals A and B. In that case, the first gain G₁ can be expressed by G₁=−(−ε/2δ+0.5)²+1, and the second gain G₂ can be expressed by G₂=−(ε/2δ+0.5)²+1, using the deviation ε between the signal A and the signal B. When a signal selected in the low select processing is the signal A, for example, the signal A is normalized, and the first gain G₁ is multiplied by the normalized signal A to obtain the first additional signal H₁, and the signal B, an unselected signal, is normalized, and the second gain G₂ is multiplied by the normalized signal B to obtain the second additional signal H₂, to obtain the smoothing signal P, so that, when the signal processing device 1 performs the low select processing to select a signal, the signals A and B can be smoothly connected at the time of switching between the signals A and B, and a sudden change in the rate of change of the signal at the time of switching between the signals A and B can be reduced.

When the low select processing is performed, the first gain G₁ and the second gain G₂ can be derived using trigonometric functions. In this case, the deviation ε is determined by ε=f₁(t)−f₂(t) where f₁(t) is the signal A and f₂(t) is the signal B, the first additional signal H₁ is determined by H₁=a2×G₁ and the second additional signal H₂ is by H₂=b2×G₂, where the first gain G₁ is G₁=[ cos{(δ+ε)π/2δ}+1]²/4 and the second gain G₂ is G₂=[ cos{(δ−ε)π/2δ}+1]²/4, and, as in the above description, a2 is the value of the normalized signal A, and b2 is the value of the normalized signal B, and for the smoothing signal P, P=δ×(H₁+H₂)+γ is calculated. In this manner, the smoothing signal P connecting both a signal before switching and a signal after switching by a smooth curve at the time of switching from the signal A to the signal B or from the signal B to the signal A can be generated, and a sudden change in the rate of change of the signal can be reduced. Although cosine functions are used for the first gain G₁ and the second gain G₂ in the above description, sine functions may be used for expression.

As above, when the deviation ε between the signal A and the signal B becomes lower than or equal to the threshold δ, the output signal adjuster 5 outputs the smoothing signal P as the output signal O, so that a sudden change in the rate of change of the output signal O at the time of switching of a selected signal can be reduced. Here, the smoothing signal P can be determined by calculating P=δ×(a2×G₁+b2×G₂)+γ, as described above. Thus, when the signal A and the signal B have the same value, and the deviation ε is zero, the value of the smoothing signal P is P=a+0.25δ=b+0.25δ (a is the value of the signal A, and b is the value of the signal B). When the absolute value of the deviation ε is a value near zero and lower than or equal to the threshold δ, the output signal adjuster 5 uses the smoothing signal P as the output signal O. When the absolute value of the deviation ε is zero; the output signal O has the value obtained by adding a value 0.25 times the threshold δ to the signal A or the signal B. That is, the value of the smoothing signal P is a value deviated from the signals A and B when either of the signals A and B is subjected to the high select processing. Then, when both the value of the signal A and the value of the signal B are zero, the value of the output signal O becomes 0.25δ, and does not become zero. For that, the smoothing processor 3 illustrated in FIG. 7 is provided with the specified range changer 312 for changing the value of the threshold δ.

The specified range changer 312 compares a reference value δini of the threshold δ with a mean value of the values of both the signal A and the signal B, changes the value of the threshold δ to the mean value when the mean value is smaller than the reference value δini, and inputs the changed threshold δ to the sudden change reduction processor 313 and the smoothing determination signal generator 314. More specifically, when the mean value of the signal A and the signal B is calculated, the specified range changer 312 compares it with the reference value δini, and updates the value of the threshold δ to the mean value when the comparison result is that the mean value is smaller than the reference value δini. The updated threshold δ is used in the calculation of the smoothing signal P by the signal generator 311 and the comparison between the absolute value of the deviation ε and the threshold δ by the smoothing determination signal generator 314. For the threshold δ, a lower limit δmin of a value larger than zero and smaller than the reference value δini is set. When the above-described mean value is smaller than the lower limit δmin, the value of the threshold δ is clamped to the lower limit δmin.

The provision of the specified range changer 312 as above prevents the output signal O from being output as a signal having a larger value than the signal A and the signal B when the signal A and the signal B take on zero or values near zero.

For example, consider the case where the signal processing device 1 is used in a suspension system in which a spring upper control current command used for the vibration damping control of a spring upper member of a vehicle and a spring lower control current command used for the vibration damping control of a spring lower member are taken in as signals to output the output signal O, and the damping force of a damper interposed between the spring upper member and the spring lower member of the vehicle is controlled based on the output signal O, and the damping force of the damper is adjusted by the output signal O. When the signal A of the two signals is selected by the high select processing, for example, and the signal processing device outputs the output signal O having a certain value deviated from the signal A even though the vehicle has stopped, both the spring upper member and the spring lower member are stationary, and both the signal A and the signal B are zero, a control command must be continuously output to the damping force adjuster of the damper even though the vehicle has stopped. By contrast, in the signal processing device 1 including the specified range changer 312, the value of the threshold δ decreases, approaching zero when the signal A and the signal B take on values near zero, so that the value of the smoothing signal P decreases. When the smoothing signal P is selected and output as the output signal O, the value of the output signal O is a small value near zero. Thus, using the signal processing device 1 as a signal processing device of a suspension system solves the problem that a control command is output to a damping force adjuster of a damper in a situation where a spring upper member and a spring lower member do not vibrate, and the signal A and the signal B are both zero, such as when the vehicle has stopped.

The reason why the minimum value δmin is set for the threshold δ is that the calculation of the smoothing signal P includes division using the threshold δ as a denominator. By setting the minimum value δmin at a value near zero such as 0.001, for example, the value of the output signal O output when the signal A and the signal B are both zero can be made a very small value near zero. By comparing the above-described mean value with the reference value δini, there is an advantage that it can be reliably determined that it is a situation where both the signal A and the signal B have small values less than the threshold δ. Further, since the signal processing device 1 performs the high select processing in this embodiment, instead of changing the threshold δ using the mean value of the signal A and the signal B, the value of the threshold δ may be updated to the value of a signal selected by the high select processing when the value of the selected signal is smaller than the reference value δini. Likewise, when the low select processing is performed, in addition to the use of the mean value of the signal A and the signal B, the value of the threshold δ may be updated to the value of a signal selected by the low select processing when the value of the selected signal is smaller than the reference value δini. Thus, the value of the threshold δ may be changed using information on the magnitude of the signal A or the signal B both in the high select processing and the low select processing.

When the mean value of the signal A and the signal B takes on a value near zero lower than or equal to the minimum value δmin even though the absolute value of the deviation ε becomes lower than or equal to the threshold δ, the output signal adjuster 5 outputs, instead of the smoothing signal P, the largest value of the signals A and B in the high select processing, and the smallest value of the signals A and B in the low select processing, as the output signal O, so that the output signal O can be made zero when both the signal A and the signal B are zero.

In the smoothing processor 3 in the present embodiment, the specified range changer 312 is provided to change the threshold δ. The threshold δ is processed in the sudden change reduction processor 313, and then input to the signal generator 311 and the smoothing determination signal generator 314. In this embodiment, the sudden change reduction processor 313 includes a low-pass filter. By filtering the threshold δ with the low-pass filter, an abrupt change in the threshold δ can be slowed, and a sudden change in the threshold δ can be reduced. That is, the processing in the sudden change reduction processor 313 reduces a sudden change in the specified range. In this manner, when the signal A and the signal B take on zero or values near zero by chance while the both signals A and B are varying in a vibrating manner at high frequencies, the threshold δ is changed to the mean value of the two signals A and B, but the processing by the sudden change reduction processor 313 prevents the threshold δ from becoming too small. Thus, even when the signal A and the signal B intersect near zero, the smoothing signal P adequately smoothes the output signal O, so that a sudden change in the output signal O is reduced even in such a situation.

In contrast, when both the signal A and the signal B gradually change to zero or values near zero, the threshold δ changes toward zero, changing in a vibrating manner, but its frequencies are low, so that the threshold δ even processed by the sudden change reduction processor 313 gradually decreases. The value of the smoothing signal P also decreases due to the decrease in the threshold δ, so that the output signal O gradually approaches zero or a value near zero, according to change in a selected signal of the signal A and the signal B. Thus, when both the signal A and the signal B gradually change to zero or values near zero, the specified range gradually decreases. When the specified range decreases, the deviation ε decreases. Thus the value of the smoothing signal P also decreases, and the output signal O gradually approaches zero or a value near zero, according to change in a selected signal of the signal A and the signal B. Therefore, when the signal processing device 1 is applied to the above-described suspension system, in a situation where the vehicle is traveling and smoothing is desired, the output signal O is smoothed even in a state where the signal A and the signal B are vibrating and the both take on zero or values near zero by chance. In a situation where smoothing is not desired. Such as when the vehicle is stopped, smoothing is not performed as desired. Thus, the signal processing device 1 is most suitable for a signal processing device in a vehicle suspension system.

The smoothing determination signal generator 314 determines the deviation ε between the signal A and the signal B, and compares it with the threshold δ processed by the sudden change reduction processor 313 to generate the smoothing determination signal Z. Specifically, when the absolute value of the deviation ε is lower than or equal to the threshold δ, the smoothing determination signal generator 314 outputs the smoothing determination signal Z of a value based on which the output signal adjuster 5 determines that the smoothing signal P be used. In contrast, when the absolute value of the deviation ε exceeds the threshold δ, the smoothing determination signal generator 314 outputs the smoothing determination signal Z of a value based on which the output signal adjuster 5 determines that the largest value signal Ma or the smallest value signal Mi be used. As described above, the smoothing determination signal generator 314 may be integrated into the normal processor 4 or the output signal adjuster 5. When the deviation ε is determined by subtracting a signal of a smaller value from a signal of a larger value, absolute value processing in the smoothing determination signal generator 314 is unnecessary. When the signal extractor 2 is configured to obtain information on which of the signal A and the signal B has a larger value, operation in the smoothing determination signal generator 314 is facilitated.

In the smoothing processor 3, the smoothing signal P is generated at all times, and the smoothing determination signal generator 314 generates the smoothing determination signal Z. The output signal adjuster 5 finally determines the validity or invalidity of the smoothing signal P. Alternatively, the smoothing signal P may be generated only within the specified range in which the absolute value of the deviation ε is lower than or equal to the threshold δ.

In the above, the smoothing processor 3 synthesizes the signal A and the signal B to generate the smoothing signal P, based on the deviation ε. A variation of the smoothing processor 3 may determine the smoothing signal P by adding an additional value to a selected signal.

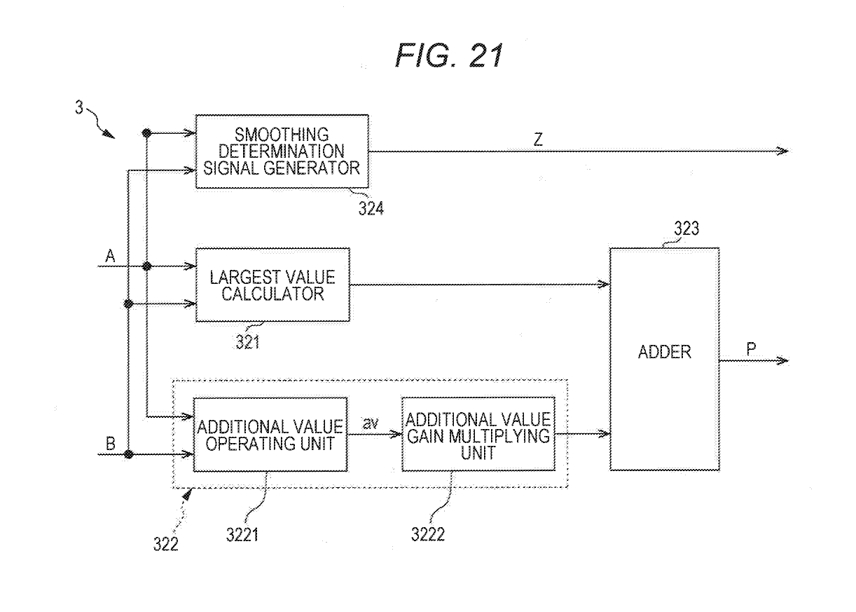

This smoothing processor 3 includes, as in a second configuration example illustrated in FIG. 21, a largest value calculator 321, an additional value calculator 322, an adder 323, and a smoothing determination signal generator 324.

To perform the high select processing, when the largest value calculator 321 receives the input of the two signals A and B, it compares the two signals A and B, selects a signal having the largest value, and outputs this.

The additional value calculator 322 determines the deviation ε between the input signal A and signal B, and determines an additional value av to be added to a selected signal of the signals A and B based on the deviation ε. The adder 323 adds the additional value av to a signal selected by the largest value calculator 321 to determine the smoothing signal P.

The additional value calculator 322 includes an additional value operating unit 3221 that determines the additional value av to he added to a selected signal based on the determined deviation ε, and an additional value gain multiplying unit 3222 as an additional value changer that multiples the additional value av by an additional value gain.

The additional value operating unit 3221 determines the additional value av from the deviation ε. Specifically, to smoothly connect the signal A and the signal B by the smoothing signal P, the smoothing signal P is y=x²−x+1 when considered in x, y coordinates with signal value taken on the y axis, and time on the x axis, as those illustrated in FIG. 10. When the high select processing is performed, the signal A is selected as a signal of the largest value before the time t0 at which the signal A and the signal B intersect in FIG. 10. Since the signal A is y=−x+1, the difference between the smoothing signal P and the signal A is expressed by the function y=x². When the difference is determined as the additional value av, the smoothing signal P can be determined only by determining and adding the additional value av to the signal A. At and after the time t0 when the signal A and the signal B intersect, the signal B is selected as a signal of the largest value. Since the signal B is y=x, the difference between the smoothing signal P and the signal B is expressed by the function y=(x−1)². That is, it is found that the smoothing signal P is a line target with a line of x=t0 it the drawing as the center.

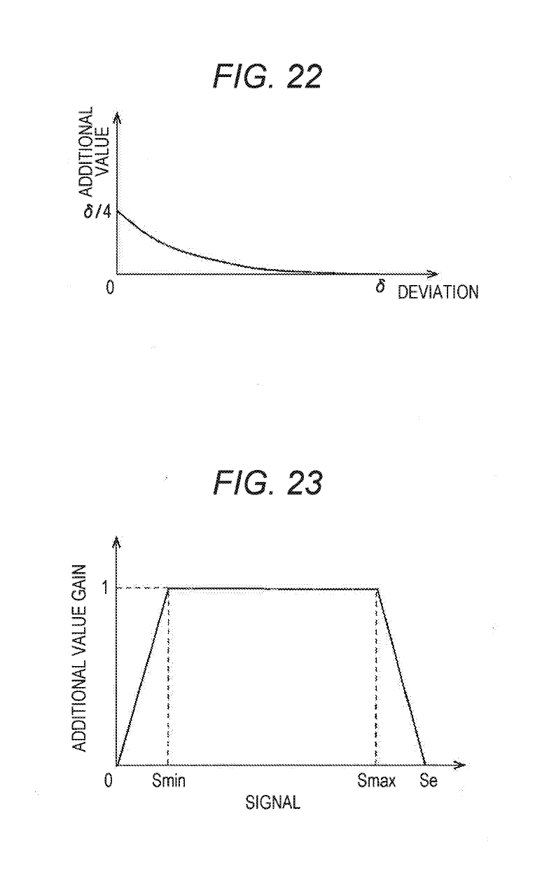

The time t0 is a point in time when the deviation ε becomes zero. Considering that the time t0 is the point in time when the deviation ε becomes zero, and the value of the difference between the smoothing signal P and the signal A and the signal B at that point in time is δ/4 when the threshold δ is used, that when the absolute value of the deviation ε becomes lower than or equal to the threshold δ, the smoothing signal P is output in place of the signal A, and further, that when the absolute value of the deviation ε becomes the threshold δ both at and before the time t0 and at and after the time t0, the additional value av becomes zero, when the difference between the signal A and the smoothing signal P rewritten into a function with the deviation ε as a parameter, the additional value av can be expressed by av=(δ−|ε|)²/4δ (where 0≦|ε|≦δ), as illustrated in FIG. 22. The additional value av can be determined by this simple calculation, and may alternatively be determined by map operation by previously mapping the relationship between the deviation ε and the additional value av. In particular, when it is difficult to express the smoothing signal P by a simple function, the relationship between the deviation ε and the additional value av may be mapped to determine the additional value av by map operation. When the absolute value of the deviation ε exceeds the threshold δ, the additional value av becomes zero. However, when the above formula is calculated to determine the additional value av, the additional value av does not become zero. Thus, when the absolute value of the deviation ε exceeds the threshold δ, the additional value av is made zero regardless of the result of calculation of the above formula. To make the additional value av zero, when the absolute value of the deviation ε exceeds the threshold δ from comparison between the absolute value of the deviation ε and the threshold δ, the additional value av may be made zero without calculating the above formula, or the additional value av may be made zero by multiplying the result of calculation of the above formula by an additional value gain.

When the additional value av is differentiated with respect to the deviation ε, the derivative value of the additional value av′=(|□|−δ)/2δ (where 0≦|ε|≦δ). When |ε|=0, the derivative value of the additional value av′=½. When |ε|=δ, the derivative value of the additional value av av′=0. The derivative value av′ of the additional value av represents the inclination of the additional value av. Thus by creating a function or a map to determine the additional value av to determine the additional value av on condition that the derivative value av′ of the additional value av be −½ when |ε|=0, and the derivative value av′ of the additional value av be −½ when |ε|=δ, and further, that the point (0, δ/4) and the point (δ, 0) in FIG. 22 be connected smoothly, the smoothing signal P smoothly connecting the signal A and the signal B can be obtained. Thus, the additional value av can be determined by the relational expression av=(δ−|ε|)²/4δ (where 0≦|ε|≦δ), or by using a function or a map designed to meet the above condition. The function or the map to determine the additional value av may be used even if the value of the derivative value av′ of the additional value when |ε|=0 and the value of the derivative value av′ of the additional value when |ε|=δ do not strictly meet the above condition, if there are no practical problems in smoothly connecting the signal A and the signal B by the smoothing signal P. Thus, the function or the map to determine the additional value av is freely adjustable to the extent that some deviation from the above condition does not cause practical problems. When the signal processing device 1 performs the low select processing, the additional value av can be determined by calculating av=−(δ−|ε|)²/4δ (where 0≦|ε|≦δ).

Next, the additional value gain multiplying unit 3222 as an additional value changer multiplies the additional value av input from the additional value operating unit 3221 by an additional value gain Kav that varies according to the values of the signals A and B, and outputs the result. The additional value gain multiplying unit 3222 uses a map illustrated in FIG. 23 in which the additional value gain is taken on the vertical axis, and the values of the signals A and B are taken on the horizontal axis, for example, to determine the additional value gain Kav based on the value of a selected signal of the signals A and B. As illustrated in the map, the additional value gain Kav takes on a value less than 1 when the value of a selected signal of the signals A and B is less than a signal lower limit threshold Smin and when it exceeds a signal upper limit threshold Smax, and otherwise is one. Specifically, the additional value gain Kav proportionally increases from zero to one as the value of a selected signal of the signals A and B changes from zero to the signal lower limit threshold Smin, and proportionally decreases from one to zero as the value of a selected signal of the signals A and B increases beyond the signal upper limit threshold Smax to a limit value Se. The signal lower limit threshold Smin is set at a small positive value near zero, and the signal upper limit threshold Smax is set at a value near an output upper limit that the signal processing device 1 can output. The limit value Se can be set as desired. When the limit value Se is exceeded, the additional value gain by which the additional value av is multiplied becomes zero.

The adder 323 adds the value of a signal of a larger value of the signals A and B to the value determined by the additional value gain multiplying unit 3222 by multiplying the additional value av by the additional value gain Kav, to output the smoothing signal P. When the absolute value of the deviation ε exceeds the threshold δ, the additional value av is made zero. Thus, the additional value av after being multiplied by the additional value gain Kav is zero when the additional value gain Kav is any value, and the result of calculation by the adder 323 is a signal itself having a larger value of the signal A and the signal B.

Accordingly, when the absolute value of the deviation ε exceeds the threshold δ, the signal processing device 1 generates a signal itself having a larger value of the signal A and the signal B as the smoothing signal P at all times. In contrast, when the absolute value of the deviation ε is lower than or equal to the threshold δ, the additional value av is a nonzero value, and further when the signal A is zero or does not exceed the limit value Se, the additional value gain Kav is not zero, and the additional value av multiplied by the additional value gain Kav is a nonzero value. Thus, this value is added to a signal having a larger value of the signal A and the signal B to generate the smoothing signal P.

Like the smoothing determination signal generator 314 described above, the smoothing determination signal generator 324 determines the deviation ε between the signal A and the signal B, and compares it with the threshold δ to generate a smoothing determination signal Z. Specifically, when the absolute value of the deviation ε is lower than or equal to the threshold δ, the smoothing determination signal generator 324 outputs the smoothing determination signal Z of a value based on which the output signal adjuster 5 determines that the smoothing signal P be used. In contrast, when the absolute value of the deviation ε exceeds the threshold δ, the smoothing determination signal generator 324 outputs the smoothing determination signal Z having a value based on which the output signal adjuster 5 can determine whether the largest value signal Ma can be used or not. The smoothing determination signal generator 324 may be integrated into the normal processor 4 or the output signal adjuster 5.

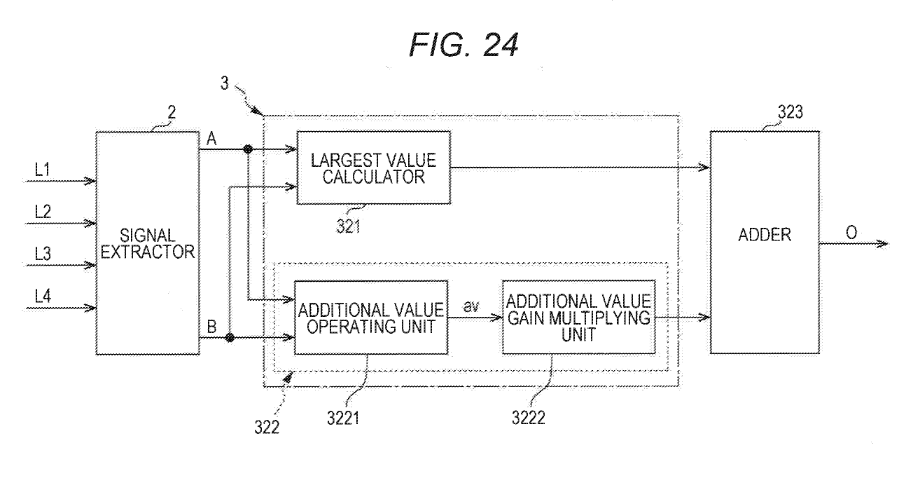

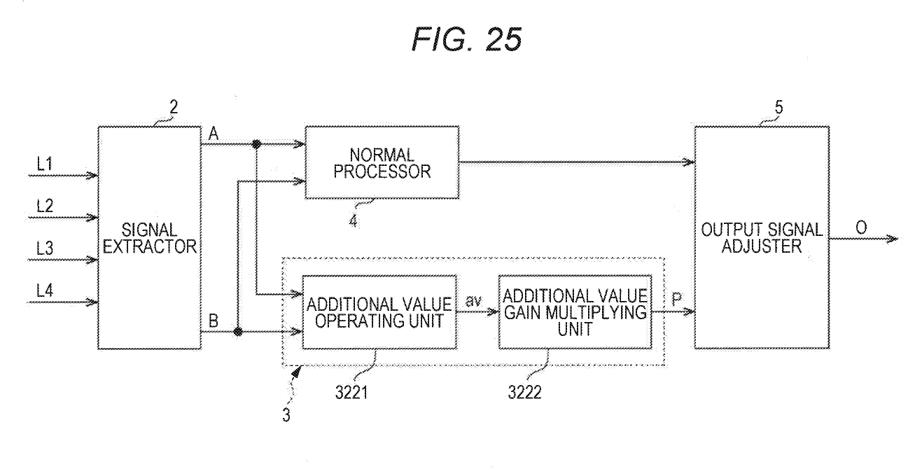

Thus, the smoothing processor 3 generates the smoothing signal P at all times, and the output signal adjuster 5 uses the smoothing signal P as the output signal O when the absolute value of the deviation ε is lower than or equal to the threshold δ, so that a sudden change in the rate of change of the signal at the time of switching between the signals A and B can be reduced. The smoothing processor 3 determines the smoothing signal P by adding the additional value av to a signal selected by the high select processing, and makes the additional value av zero when the deviation ε is not within the specified range. Thus, by outputting the smoothing signal P determined by adding the additional value av to a selected signal of the signals A and B as the output signal O at all times, a sudden change in the rate of change of the signal can be reduced at the time of switching between the signals A and B. Thus, when the additional value av is determined to output the smoothing signal P, as in a signal processing device in a second embodiment illustrated in FIG. 24, the smoothing signal generator 324, the normal processor 4, and the output signal adjuster 5 may be eliminated in a mode in which the smoothing signal P is used directly as the output signal O. Instead of using the smoothing signal P in place of the signal A or the signal B as in the above description, as in a signal processing device in a third embodiment illustrated in FIG. 25, the smoothing processor 3 may eliminate the largest value calculator 321 and the smoothing signal generator 324, determine only the additional value av, and output the additional value av as the smoothing signal P, and a signal output by the normal processor 4 may be added to the additional value av by the output signal adjuster 5 to be output as the output signal O. When the smoothing processor 3 determines the additional value av, in a situation where the absolute value of the deviation ε exceed the threshold δ, and the deviation ε exceeds the specified range, the additional value av takes on zero, and when the deviation ε is within the specified range, the additional value av of a value that allows reduction of a sudden change in the rate of change of the signal is output. Thus, when the additional value av is output as the smoothing signal P, by outputting a selected signal to which the additional value av has been added at all times, a signal that can automatically reduce the value of the signal is output. This also results in the smoothing signal P validated in the specified range.

The smoothing processor 3 has the additional value gain multiplying unit 3222 as an additional value changer. When a selected signal of the signals A and B is less than the signal lower limit threshold Smin and when it exceeds the signal upper limit threshold Smax, the additional value av is multiplied by an additional value gain Kav of a value less than one to decrease the additional value av.

Since the additional value gain multiplying unit 3222 multiplies the additional value av by an additional value gain to make the value of the additional value av smaller than the additional value av calculated by the additional value operating unit 3221 when a selected signal of the signals A and B is less than the signal lower limit threshold Smin, even if the additional value av is superimposed when a selected signal of the signals A and B takes on a value near zero, the smoothing signal P with a small deviation from the selected signal of the signals A and B can be output.

Consider the case where the signal processing device 1 is applied to a suspension system in which a spring upper control current command used for the vibration damping control of a spring upper member of a vehicle and a spring lower control current command used for the vibration damping control of a spring lower member are taken in as signals to generate a control command, and the damping force of a damper interposed between the spring upper member and the spring lower member of the vehicle is controlled based on the control command, and the damping force of the damper is adjusted by the smoothing signal P. This eliminates the smoothing signal P greatly deviating from a selected signal of the signals A and B, being output from the signal processing device 1 although the vehicle has stopped, both the spring upper member and the spring lower member are stationary, and a selected signal of the signals A and B is zero. When the signal processing device 1 is applied to a suspension system as described above, as illustrated in FIG. 23, on the additional value gain Kav when a selected signal of the signals A and B is less than the signal adjustment threshold Smin, the additional value gain Kav is set to become zero when a selected signal of the signals A and B becomes zero, so that the smoothing signal P can be made zero when the selected signal of the signals A and B is zero. This avoids such a situation where a nonzero control command continues to be output to the damping force adjuster of the damper although the vehicle has stopped.

When a selected signal of the signals A and B exceeds the signal upper limit threshold Smax, the additional value gain multiplying unit 3222 multiplies the additional value av by an additional value gain to make the value of the additional value av smaller than the additional value av calculated by the additional value operating unit 3221. Thus, when a selected signal of the signals A and B has a value near the signal upper limit that the signal processing device 1 can output, the smoothing processor 3 decreases the additional value av by the additional value gain multiplying unit 3222. Thus, even when the signal processing device 1 outputs the smoothing signal P, a limiter function of clamping the smoothing signal P to the output upper limit of the signal processing device 1 is provided. The installation of the additional value gain multiplying unit 3222 is optional, and it may be eliminated.

When the low select processing is performed, unlike the high select processing, a signal of a lower value of the signal A and the signal B is selected in the determination of the additional value gain Kav in the additional value gain multiplying unit 3222. Thus using the value of a signal of a lower value or using a mean value of the signals A and B, this value can be compared with the signal lower limit threshold Smin and the signal upper limit threshold Smax to determine the additional value gain Kav. Thus, the additional value gain multiplying unit 3222 changes the additional value gain Kav, according to information on the magnitude of one or both of the signals A and B, so that the smoothing signal P can be made zero in such a case where a selected signal of the signals A and B becomes zero, and the smooth signal P can be prevented from exceeding the output upper limit of the signal processing device 1. When the low select processing is performed, the smoothing processor 3 may add a signal selected by the low select processing to the additional value av to determine the smoothing signal P in a mode of using this as the output signal O, or may output the additional value av as the smoothing signal P to cause the output signal adjuster 5 to add the additional value av to a signal selected by the low select processing to determine and output the output signal O.

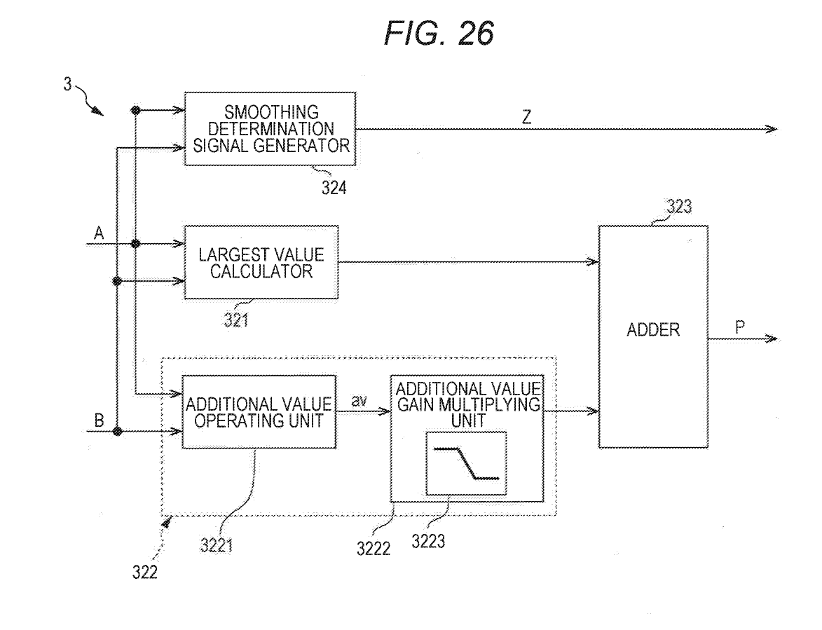

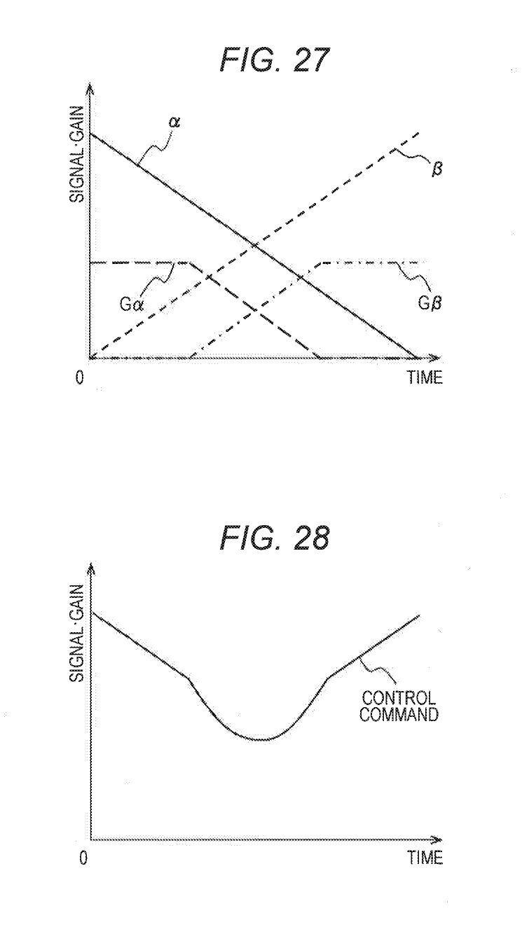

As in a third configuration example illustrated in FIG. 26, the smoothing processor 3 may be provided with a gain sudden change reducing unit 3223 that reduces a sudden change in the additional value gain Kav determined by the additional value gain multiplying unit 3222. The gain sudden change reducing unit 3223 is a low-pass filter in this example. By subjecting the additional value gain Kav to low-pass filter processing, a sudden change in the additional value gain Kav can be reduced. Thus, when a selected signal of the signals A and B becomes zero or a value near zero by chance while the selected signal is varying in a vibrating manner at high frequencies, the value of the additional value gain Kav is changed, but the low-pass filter processing prevents a sudden change in the value, so that the smoothing processing is performed to reduce a sudden change in the value of the output signal O. In contrast, when both the signal A and the signal B gradually change to zero or values near zero, the rate of change of the additional value gain Kav is also low, and thus the additional value gain Kav even processed by the gain sudden change reducing unit 3223 gradually decreases. The decrease in the additional value gain Kav causes the value of the smoothing signal P to also decrease, so that the output signal O gradually approaches zero or a value near zero, according to change in a signal selected by the high select processing or the low select processing. When the signal processing device 1 is applied to the above-described suspension system, in a situation where the vehicle is traveling and smoothing is desired, the smoothing processing on the output signal O is performed even in a state where the signal A and the signal B are vibrating at high frequencies and the both take on zero or values near zero by chance. In a situation where smoothing is not desired, such as when the vehicle is stopped, the smoothing processing is not performed as desired. Thus, the signal processing device 1 is most suitable for a signal processing device in a vehicle suspension system.

In the above description, description has been made on the assumption that a signal having a positive value is processed. For a signal having a negative value, a minus lower limit may be corrected to zero to be applied to the present invention, and finally subjected to processing to bring it back by the corrected quantity. Further, both in the high select processing and the low select processing, offset of a signal or reversal of a signal in signal sign allows for the application of the present invention. When a signal is offset, processing to bring it back by the offset quantity may be performed.

The signal processing device 1 is configured as above. When the plurality of signals L1, L2, L3, and L4 is input to the signal processing device 1, the signal extractor 2 extracts the signal A and the signal B, and the smoothing processor 3 generates the smoothing signal P based on the deviation ε.

When a signal of a larger value is selected, the smoothing signal P is generated based on the deviation ε such that the smoothing signal P has a value larger than the values of the two signals A and B between the two points at which the smoothing signal P intersects the two signals A and B. When a signal of a smaller value is selected, the smoothing signal P is generated based on the deviation ε such that the smoothing signal P has a value smaller than the values of the two signals A and B between the two points at which the smoothing signal P intersects the two signals A and B. Consequently, the inclination of the smoothing signal P becomes larger than the inclination of the signal A while the signal A is selected, and the inclination of the smoothing signal P becomes smaller than the inclination of the signal B while the signal B is selected. Compared to switching a selected signal directly from the signal A to the signal B at the time of switching between the two signals A and B, by using the generated smoothing signal P between the two points from the intersection of the smoothing signal P and the signal A to the intersection of the smoothing signal P and the signal B, the signal processing device 1 can reduce a sudden chance in the rate of change of the signal at the time of switching between the signals A and B. Thus, the signal processing device 1 in the present invention can reduce the rate of change of the signal at the time of signal switching between the signal A and the signal B.

Further, in a plane with a signal magnitude axis and a time axis, when a signal of a larger value of the signals A and B is selected, in addition to the condition that the smoothing signal P always have a larger value than the two signals A and B between the two points at which the smoothing signal P intersects the two signals A and B, the smoothing processor 3 generates the smoothing signal P such that the smoothing signal P has a smaller value than a straight line connecting the coordinates of the value of a signal selected at a time when the deviation ε falls within the specified range, and the coordinates of the value of a signal selected at a time when the deviation ε falls out of the specified range. When a signal of a smaller value of the signals A and B is selected, in addition to the condition that the smoothing signal P always have a smaller value than the two signals A and B between the two points at which the smoothing signal P intersects the two signals A and B, the smoothing processor 3 generates the smoothing signal P such that the smoothing signal P has a larger value than a straight line connecting the coordinates of the value of a signal selected at a time when the deviation ε falls within the specified range, and the coordinates of the value of a signal selected at a time when the deviation ε falls out of the specified range. This case provides advantages below. By the smoothing signal P being generated in this range, the inclination of the smoothing signal P becomes larger than the inclination of the signal A while the signal A is selected, and inclination of the smoothing signal P becomes smaller than the inclination of the signal B while the signal B is selected, and in addition, the signals A and B can be smoothly connected. Thus, the signal processing device 1 can more reliably reduce a sudden change in the rate of change of the signal.

Further, when the output signal adjuster that outputs one of a selected signal of the two signals A and B and the smoothing signal P as the output signal O uses the smoothing signal P as the output signal O when the deviation ε between the two signals A and B is within the specified range, the smoothing signal P is output when the deviation ε is within the specified range. Thus, when the values of the signals A and B come closer to each other, and signal switching is expected, the smoothing signal P can be used. In addition, when the values of the signals A and B are completely apart and the smoothing processing is unnecessary, the use of the smoothing signal P can be prevented. Thus, at the time of switching from a selected signal to a different signal, the signals are smoothly switched to smooth the output signal O, and a sudden change in the rate of change of the output signal O can be reduced.

When the signal processing device 1 changes the specified range based on information on the magnitude of one or both of two signals, the signal processing device 1 can change the threshold δ to a smaller value close to zero when the signal A and the signal B take on values near zero. This decreases the value of the smoothing signal P to be output as the output signal O, so that the value of the output signal O becomes a small value near zero. When the signal A and the signal B take on values near zero, the output signal O can be made to take on zero or a value near zero. Thus, using the signal processing device 1 for control signal processing, zero can be output when an output signal as a control signal must be made zero, eliminating useless power consumption on the controller side. Thus, for example, when the signal processing device 1 is used as a signal processing device for a suspension system in which a spring upper control current command and a spring lower control current command used for the vibration damping control of a spring lower member are taken in as the signals A and B, the problem that a control command to a damping force adjuster of a damper becomes too large in a situation where the spring upper member and the spring lower member do not vibrate and both the signal A and the signal B are zero, such as when the vehicle has stopped, can be solved, reducing power consumption.

Next, when the signal processing device 1 has a sudden change reduction processor that reduces a sudden change in the specified range, the specified range is prevented from becoming too small when both the signal A and the signal B become zero or values near zero by chance while the both signals are varying in a vibrating manner at high frequencies. Thus, even when the signal A and the signal B intersect near zero, the smoothing signal P adequately smoothes the output signal O, so that the signal processing device 1 can reduce a sudden change in the output signal O even in such a situation. In contrast, when both the signal A and the signal B gradually change to zero or values near zero, the specified range gradually decreases, and the value of the smoothing signal P also decreases with the reduction in the specified range. Thus, the output signal O gradually approaches zero or a value near zero, according to change in a selected signal of the signal A and the signal B. Therefore, when the signal processing device 1 is applied to the above-described suspension system, in a situation where the vehicle is traveling and smoothing is desired, the output signal O is smoothed even in a situation where the signal A and the signal B are vibrating and the both take on zero or values near zero by chance. In a situation where smoothing is not desired, such as when the vehicle is stopped, smoothing is not performed as desired. The signal processing device 1 is most suitable for a signal processing device in a vehicle suspension system.

Since the smoothing processor 3 generates the smoothing signal P such that the difference between the smoothing signal P and the selected signal A or B decreases with increases in the deviation ε between the two signals A and B, the smoothing signal P can be generated as a smooth curve, and both a connection between the signal A and the smoothing signal P and a connection between the signal B and the smoothing signal P become smooth. Thus, the signal processing device 1 can obtain the smoothing signal P most suitable for smoothing the two signals A and B.

When the smoothing processor 3 generates the smoothing signal P by adding the additional value av determined based on the deviation ε to a selected signal of the signals A and B, the signal processing device 1 can easily determine the smoothing signal P ideal for smoothly connecting the signals to each other, and can more effectively reduce a sudden change in the rate of change of the output signal O.

When the smoothing processor 3 has an additional value changer that changes the additional value av based on information on the magnitude of one or both of the two signals A and B, the signal processing device can achieve effects below. Reducing the additional value av when a selected signal of the signals A and B is less than the signal lower limit threshold Smin eliminates the smoothing signal P greatly deviating from the selected signal of the signals A and B, being output from the signal processing device 1 although the selected signal of the signals A and B is zero. When a selected signal of the signals A and B exceeds the signal upper limit threshold Smax, by reducing the additional value av, a limiter function of clamping the smoothing signal P to the output upper limit of the signal processing device 1 is provided even when the signal processing device 1 outputs the smoothing signal P, when the selected signal of the signals A and B has a value near the signal upper limit that the signal processing device 1 can output. Thus, the signal processing device 1 is most suitable for a suspension system, and can reduce system power consumption and provide a limiter function, and eliminates the need to additionally provide a limiter on the system side.

Further, when the additional value av is expressed using a quadratic function of the deviation ε between the two signals A and B, the signal processing device 1 can determine the smoothing signal P ideal for smoothly connecting the signals to each other only by performing a simple calculation, and can more effectively reduce a sudden change in the rate of change of the output signal O.

When the signal extractor 2, which extracts the two signals A and B having the largest value and the second largest value, or extracts the two signals A and B having the smallest value and the second smallest value from three or more signals L1, L2, L3, and L4, and inputs the extracted two signals to the smoothing processor 3, is included, the signal extractor 2 extracting the two signals A and B eliminates the need to change the processing procedure of the smoothing processor 3 even when signals increase, thus facilitating programming.

That concludes the description of the embodiments of the present invention. The scope of the present invention is not limited to the illustrated or described details themselves as a matter of course.

This application claims a priority based on Patent Application No. 2014-245979, filed to the Japan Patent Office on Dec. 4, 2014. This application is incorporated herein by reference in its entirety.

1. A signal processing device that generates a smoothing signal when a selected signal of input two signals is switched, the device comprising:
a smoothing processor that, when a signal of a larger value is selected, generates a smoothing signal having a value larger than values of the two signals between two points at which the smoothing signal intersects the two signals before and after switching between the two signals, based on a deviation between the two signals, and, when a signal of a smaller value is selected, generates a smoothing signal having a value smaller than values of the two signals between two points at which the smoothing signal intersects the two signals before and after switching between the two signals, based on a deviation between the two signals.

2. The signal processing device according to claim 1, wherein
in a plane with a signal magnitude axis and a time axis,
when a signal of a larger value is selected, the smoothing processor generates a smoothing signal such that the smoothing signal has a smaller value than a straight line connecting coordinates of a value of a signal selected at a time when the deviation falls within a specified range, and coordinates of a value of a signal selected at a time when the deviation falls out of the specified range, and
when a signal of a smaller value is selected, the smoothing processor generates a smoothing signal such that the smoothing signal has a larger value than a straight line connecting coordinates of a value of a signal selected at a time when the deviation falls within a specified range, and coordinates of a value of a signal selected at a time when the deviation falls out of the specified range.

3. The signal processing device according to claim 1, wherein
in a plane with a signal magnitude axis and a time axis,
when a signal of a larger value is selected, when the deviation falls within a specified range, the smoothing processor generates a smoothing signal such that the smoothing signal is smaller than a value obtained by adding, to a value of the selected signal, one half a value obtained by subtracting an absolute value of the deviation from a threshold setting the specified range, and
when a signal of a smaller value is selected, when the deviation falls within a specified range, the smoothing processor generates a smoothing signal such that the smoothing signal is larger than a value obtained by subtracting, from a value of the selected signal, one half a value obtained by subtracting an absolute value of the deviation from a threshold setting the specified range.

4. The signal processing device according to claim 1, wherein
the smoothing processor generates the smoothing signal such that a difference between the smoothing signal and the selected signal decreases with increases in the deviation between the two signals.

5. The signal processing device according to claim 1, wherein the smoothing processor generates the smoothing signal by adding an additional value determined based on the deviation to the selected signal.

6. The signal processing device according to claim 5, wherein
the smoothing processor has an additional value changer that changes the additional value based on information on magnitude of one or both of the two signals.

7. The signal processing device according to claim 5, wherein
the additional value is expressed using a quadratic function of the deviation between the two signals.

8. The signal processing device according to claim 1, further comprising:
an output signal adjuster that outputs one of a selected signal of the two signals and the smoothing signal as an output signal,
the output signal adjuster using the smoothing signal when the deviation between the two signals is within a specified range.

9. The signal processing device according to claim 8, wherein
the specified range is changed based on information on magnitude of one or both of the two signals.

10. The signal processing device according to claim 9, further comprising:
a sudden change reduction processor that reduces a sudden change in the specified range.

11. The signal processing device according to claim 1, further comprising:
a signal extractor that extracts two signals having a largest value and a second largest value or extracts two signals having a smallest value and a second smallest value from three or more signals, and inputs the extracted two signals to the smoothing processor.
